(19) United States
(12) Patent Application Publication
(10) Pub. No.: US 2013/0135255 A1
(43) Pub. Date: May 30, 2013

(54) DISPLAY SYSTEMS INCLUDING OPTICAL TOUCHSCREEN

(71) Applicants: Brian J. Gally, Los Gatos, CA (US); Jonathan Charles Griffiths, Fremont, CA (US)

(72) Inventors: Brian J. Gally, Los Gatos, CA (US); Jonathan Charles Griffiths, Fremont, CA (US)

(73) Assignee: QUALCOMM MEMS Technologies, Inc., San Diego, CA (US)

(21) Appl. No.: 13/308,395

(22) Filed: Nov. 30, 2011

(51) Int. Cl. G06F 3/042; H01J 9/00

(52) U.S. Cl. 345/175; 445/24

(57) ABSTRACT

This disclosure provides systems, methods and apparatus for a display device having a front light to provide front illumination to the display element included in the display device and an optical touch screen to provide a touch input to the display device. In one aspect, the display device includes a light source disposed to inject light into a backplate of the display device rearward of the display elements and a light redirector disposed to receive light from the backplate and redirect the received light forward of the display elements for optical touch purpose.

### TECHNICAL FIELD

This disclosure relates to optical touch screen and to the field of displays and electromechanical systems based display devices.

### DESCRIPTION OF THE RELATED TECHNOLOGY

Electromechanical systems include devices having electrical and mechanical elements, actuators, transducers, sensors, optical components (e.g., mirrors) and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of electromechanical systems device is called an interferometric modulator (IMOD). As used herein, the term interferometric modulator or interferometric light modulator refers to a device that selectively absorbs and/or reflects light using the principles of optical interference. In some implementations, an interferometric modulator may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a reflective membrane separated from the stationary layer by an air gap. The position of one plate in relation to another can change the optical interference of light incident on the interferometric modulator. Interferometric modulator devices have a wide range of applications, and are anticipated to be used in improving existing products and creating new products, especially those with display capabilities.

Such display devices may include touch screens. Computers and other electronics devices such as cellular phones, smart phones, personal digital assistants (PDAs) and hand-held games having displays with touch screen are highly desirable since they can enable a user to interact directly with what is displayed, rather than indirectly with an intermediate device. A variety of approaches have been used to provide displays with touch screens. One approach is a resistive touch screen which can be fragile and susceptible to damage. Another approach is a capacitive touch screen, which can require a special capacitive stylus for operation and thus may not be desirable for use in personal communication devices.

### SUMMARY

The systems, methods and devices of the disclosure each have several innovative aspects, no single one of which is solely responsible for the desirable attributes disclosed herein.

One innovative aspect of the subject matter described in this disclosure can be implemented in a display device including a display touch surface, a plurality of light modulating elements that are configured to form a display image and disposed rearward of the display touch surface, a substrate that is integral with the display device and is disposed rearward of the plurality of light modulating elements, at least one light source disposed to inject light into the substrate, one or more sensors and a first light redirector portion disposed laterally with respect to the plurality of light modulating elements. The first light redirector portion is configured to receive light from an edge of the substrate that is proximal to the first light redirector portion and direct a first portion of the received light forward of the display touch surface. The one or more sensors are disposed so as to receive at least some of the first portion of the received light.

In some implementations of the display device the substrate can include a display backplate that encloses the plurality of light modulating elements to insulate the plurality of light modulating elements from the external environment. In various implementations, the plurality of light modulating elements can be disposed on the substrate. In some implementations, a cladding layer can be disposed between the plurality of light modulating elements and the substrate. In various implementations, the display device can include a second light redirector portion that is configured to receive light propagating forward of the display touch surface and direct the light propagating forward of the touch surface towards the one or more sensors. In various implementations, the second light redirector portion can be configured to receive light from the at least one light source and direct the light into an edge of the substrate that is distal to the first light redirector portion. In various implementations, the one or more sensors can be disposed rearward of the plurality of light modulating elements. In various implementations, the first and second light redirector portions can include an asymmetric parabolic reflector. In various implementations, the display touch surface can have forward and rearward surfaces that extend in longitudinal (x) and transverse (y) directions and the first and/or second light redirector portions can be curved in the longitudinal and transverse directions, the curve having a parabolic shape so as to spread light across the forward surface of the display touch surface.

In various implementations, the display device can include a light guide disposed forward of the plurality of light modulating elements, wherein the first light redirector portion is configured to direct a second portion of the light received from the at least one light source into an edge of the light guide to provide front illumination. The light guide can includes a plurality of turning features that are configured to direct light propagating therein towards the plurality of light modulating elements to provide front illumination. In various implementations, the light source can be disposed rearward of the substrate or adjacent the substrate. In some implementations, the light source can be disposed rearward of the plurality of light modulating elements or rearward of the display touch surface. In some implementations, the light source can be disposed to illuminate a first and a second edge of the substrate, the first and the second edges can intersect each other at an angle. In some implementations, the light source can be disposed to inject light into a corner of the substrate. In various implementations, the one or more sensors can be disposed rearward of the plurality of the light modulating elements or rearward of the light source. In various implementations, the one or more sensors and the at least one light source can be disposed on the same side of the display device. In other implementations, the one or more sensors and the at least one light source can be disposed on opposite sides of the display device. In various implementations, the one or more sensors can include a high resolution detector having a spatial resolution between approximately 10 microns-100 microns.

One innovative aspect of the subject matter described in this disclosure can be implemented in a display device including a display touch surface, a plurality of means for modulating light disposed rearward of the display touch surface and configured to form a display image, a substrate that is integral with the display device and disposed rearward of the plurality of light modulating means, at least one means for illumination disposed to inject light into the substrate, one or more means for sensing light and a first means for redirecting light disposed laterally with respect to the plurality of light modulating means and configured to receive light from an edge of the substrate that is proximal to the first light redirecting means and direct a first portion of the received light forward of the display touch surface towards the one or more sensing means, wherein the directed first portion of light propagates forward of the touch surface.

In various implementations of the display device, the plurality of light modulating means can include a plurality of light modulating elements, or the at least one illumination means can include at least one light source, or the first light redirecting means can include a first light redirector; or the one or more sensing means can include one or more sensors. In various implementations, the plurality of light modulating elements can include at least one interferometric modulator. In some implementations, the first light redirector can include an asymmetric parabolic reflector.

Another innovative aspect of the subject matter described in this disclosure can be implemented in a method of manufacturing a display device, the method including providing a display touch surface, providing a plurality of light modulating elements rearward of the display touch surface, disposing a substrate rearward of the plurality of light modulating elements, providing at least one light source to inject light into the substrate, providing one or more sensors and disposing a first light redirector laterally with respect to the plurality of light modulating elements. The first light redirector is configured to receive light from an edge of the substrate that is proximal to the first light redirector and direct a first portion of the received light forward of the display touch surface towards the one or more sensors such that the directed first portion of light propagates forward of the touch surface. The substrate is integral with the display device. In various implementations the substrate can include a backplate of the display device.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of an isometric view depicting two adjacent pixels in a series of pixels of an interferometric modulator (IMOD) display device.

FIG. 2 shows an example of a system block diagram illustrating an electronic device incorporating a 3×3 interferometric modulator display.

FIG. 3A shows an example of a partial cross-section of the interferometric modulator display of FIG. 1.

FIGS. 3B-3E show examples of cross-sections of varying implementations of interferometric modulators.

FIGS. 4A and 4B schematically illustrate a perspective view of two different implementations of a display device, which may include an array of interferometric modulators and including a front illuminator.

FIG. 4C schematically illustrates an implementation of a display backplate.

FIG. 4D schematically illustrates a perspective view an implementation of a display device, which may include an array of interferometric modulators and including a light redirector.

FIGS. 4E and 4F schematically illustrate the top view of two different implementations of a display device, which may include an array of interferometric modulators and including a light redirector.

FIG. 4G illustrates a light redirector that can be used in a display device as shown in FIG. 4D and in other implementations such as described herein.

FIG. 5 schematically illustrates a perspective view of an implementation of an optical touch screen.

FIG. 6A schematically illustrates a perspective view of an implementation of a display device having a front light guide and including an optical touch screen.

FIGS. 6B-6D schematically illustrate the top view of two different implementations of a display device with combined front illumination and optical touch screen.

FIGS. 6E-6H illustrate cross-sectional views of various implementations of a display device including an optical touch screen and a front light guide for illumination.

FIGS. 7A-7D illustrate cross-sectional views of various implementations of a display device including an optical touch screen and a light source configured to inject light into a backplate of the display device.

FIGS. 8A and 8B show examples of system block diagrams illustrating a display device that includes a plurality of interferometric modulators.

Like reference numbers and designations in the various drawings indicate like elements.

### DETAILED DESCRIPTION

The following detailed description is directed to certain implementations for the purposes of describing the innovative aspects. However, the teachings herein can be applied in a multitude of different ways. The described implementations may be implemented in any device that is configured to display an image, whether in motion (e.g., video) or stationary (e.g., still image), and whether textual, graphical or pictorial. More particularly, it is contemplated that the implementations may be implemented in or associated with a variety of electronic devices such as, but not limited to, mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, GPS receivers/navigators, cameras, MP3 players, camcorders, game consoles, wrist watches, clocks, calculators, television monitors, flat panel displays, electronic reading devices (e.g., e-readers), computer monitors, auto displays (e.g., odometer display, etc.), cockpit controls and/or displays, camera view displays (e.g., display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (e.g., MEMS and non-MEMS), aesthetic structures (e.g., display of images on a piece of jewelry) and a variety of electromechanical systems devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes, and electronic test equipment. Thus, the teachings are not intended to be limited to the implementations depicted solely in the Figures, but instead have wide applicability as will be readily apparent to a person having ordinary skill in the art.

As discussed more fully below, in certain implementations an optical touch screen can be included with the display device to allow a user to interact with the display device. A display device having an optical touch screen includes a touch surface positioned forward of the display device, an illumination assembly configured to direct light forward of the touch surface and one or more sensors configured to receive the light propagating forward of the touch surface. The position of an object (for example, a pen, a finger, a stylus, etc.) obstructing or interrupting the path of light propagating forward of the touch surface can be determined by identifying those sensors that are blocked, thus providing a touch input to the display device. Various implementations of the display device having an optical touch screen described herein include a display touch surface forward of a plurality of display elements. The plurality of display elements can be sealed and protected from the external environment with a display backplate positioned rearward of the plurality of display elements. At least one light source can be included rearward of the plurality of display elements to inject light in to the backplate of the display device. Light injected into the backplate of the display device can propagate within the backplate by multiple total internal reflections. The light which is propagating rearward of the display elements is turned or redirected by a light redirector such that it propagates forward of the display touch surface for use as an optical touch screen. Accordingly, the illumination assembly configured to provide illumination for optical touch purpose can include the light source, the backplate and the light redirector. In various implementations, the light redirector may be configured to redirect the light as a collimated sheet of light that is spread across the entire display touch surface. In various implementations, the light redirector can include an asymmetric parabolic mirror that has a parabolic shape as seen from the front of the display device. The display device can further include one or more sensors that can be disposed over the display touch surface or rearward of the plurality of display elements. The one or more sensors can be configured to sense or detect the light propagating forward of the display touch surface. In implementations of the display device where the one or more sensors are disposed rearward of the display device, an additional light redirector may be provided to receive the light propagating forward of the display and direct the received light towards the sensors.

In various implementations, the illumination assembly that is used to provide illumination for optical touch purpose can also be used to provide front illumination to the plurality of display elements. Such implementations, can include a front light guide forward of the plurality of display elements. The light redirector that is configured to direct light forward of the touch surface can be configured to inject a portion of the light from the light source into the front light guide. The front light guide can include a plurality of turning features that can direct the light out of the front light guide towards the plurality of display elements.

Particular implementations of the subject matter described in this disclosure can be implemented to realize one or more of the following potential advantages. The geometry of the various implementations described herein, for example, can provide for a more compact display module that can provide front illumination and an optical touch input to enhance interaction with the display device. Providing the at least one light source rearward of the plurality of display elements proximal to an edge of the backplate of the display device allows for a compact design by making more efficient use of available space, since the light source can occupy dead space that was not used for any purpose. Moreover, since the light source can be designed to have a thickness less than a thickness of the backplate, positioning the light source proximal to an edge of the backplate of the display device does not adversely impact the overall thickness of the device. Also, injecting light into the backplate of the display device can allow light from the light source to diverge before being directed across the touch surface such that light from the light source spreads across the touch surface. This can advantageously reduce the number of light sources that are used to illuminate an unit area of the touch surface as compared to illuminating an unit area of the touch surface with edge illuminators. Additionally, in some embodiments, the use of a single light source for both touch and front illumination can allow a touch system to be implemented at a further reduction in cost and component count compared to systems including separate illumination systems for front illumination and touch purposes.

An example of a suitable MEMS device, to which the described implementations may apply, is a reflective display device. Reflective display devices can incorporate interferometric modulators (IMODs) to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the interferometric modulator. The reflectance spectrums of IMODs can create fairly broad spectral bands which can be shifted across the visible wavelengths to generate different colors. The position of the spectral band can be adjusted by changing the thickness of the optical resonant cavity, i.e., by changing the position of the reflector.

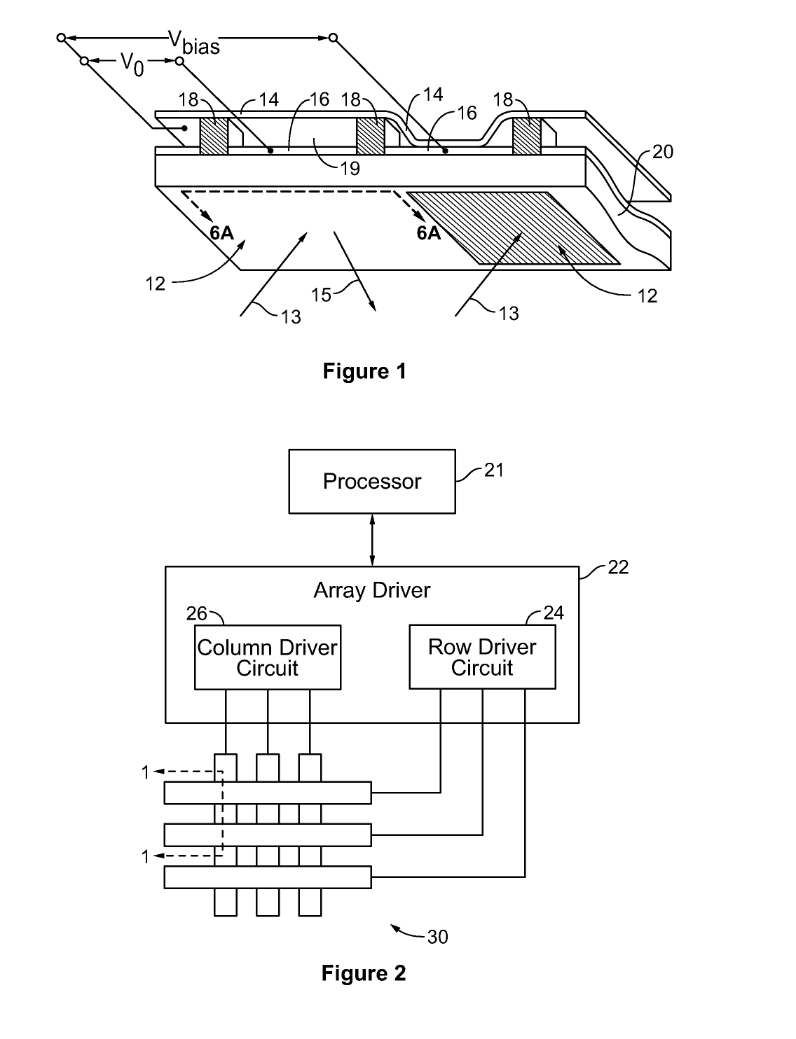

FIG. 1 shows an example of an isometric view depicting two adjacent pixels in a series of pixels of an interferometric modulator (IMOD) display device. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. In some implementations, the light reflectance properties of the on and off states may be reversed. MEMS pixels can be configured to reflect predominantly at particular wavelengths allowing for a color display in addition to black and white.

The IMOD display device can include a row/column array of IMODs. Each IMOD can include a pair of reflective layers, i.e., a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when actuated, reflecting light outside of the visible range (e.g., infrared light). In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted portion of the pixel array in FIG. 1 includes two adjacent interferometric modulators 12. In the IMOD 12 on the left (as illustrated), a movable reflective layer 14 is illustrated in a relaxed position at a predetermined distance from an optical stack 16, which includes a partially reflective layer. The voltage V₀ applied across the IMOD 12 on the left is insufficient to cause actuation of the movable reflective layer 14. In the IMOD 12 on the right, the movable reflective layer 14 is illustrated in an actuated position near or adjacent the optical stack 16. The voltage V_{bias} applied across the IMOD 12 on the right is sufficient to maintain the movable reflective layer 14 in the actuated position.

In FIG. 1, the reflective properties of pixels 12 are generally illustrated with arrows indicating light 13 incident upon the pixels 12, and light 15 reflecting from the pixel 12 on the left. Although not illustrated in detail, it will be understood by a person having ordinary skill in the art that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the pixel 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, e.g., chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and conductor, while different, more conductive layers or portions (e.g., of the optical stack 16 or of other structures of the IMOD) can serve to bus signals between IMOD pixels. The optical stack 16 also can include one or more insulating or dielectric layers covering one or more conductive layers or a conductive/absorptive layer.

In some implementations, the layer(s) of the optical stack 16 can be patterned into parallel strips, and may form row electrodes in a display device as described further below. As will be understood by one having skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be approximately 1-1000 um, while the gap 19 may be less than 10,000 Angstroms (Å).

In some implementations, each pixel of the IMOD, whether in the actuated or relaxed state, is essentially a capacitor formed by the fixed and moving reflective layers. When no voltage is applied, the movable reflective layer 14 remains in a mechanically relaxed state, as illustrated by the pixel 12 on the left in FIG. 1, with the gap 19 between the movable reflective layer 14 and optical stack 16. However, when a potential difference, e.g., voltage, is applied to at least one of a selected row and column, the capacitor formed at the intersection of the row and column electrodes at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated pixel 12 on the right in FIG. 1. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 2 shows an example of a system block diagram illustrating an electronic device incorporating a 3×3 interferometric modulator display. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, e.g., a display array or panel 30. The cross section of the IMOD display device illustrated in FIG. 1 is shown by the lines 1-1 in FIG. 2. Although FIG. 2 illustrates a 3×3 array of IMODs for the sake of clarity, the display array 30 may contain a very large number of IMODs, and may have a different number of IMODs in rows than in columns, and vice versa.

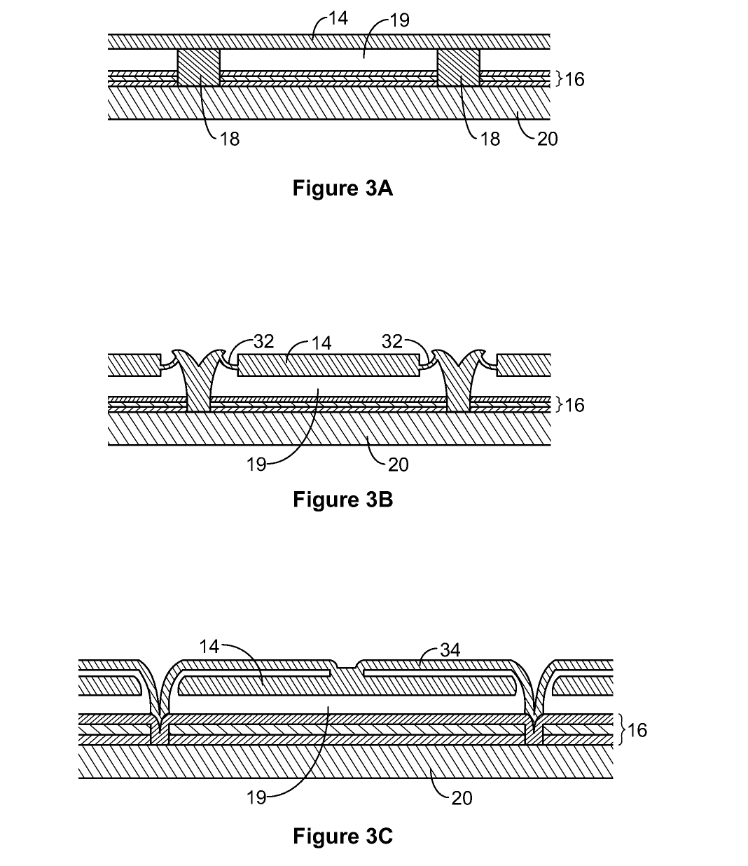

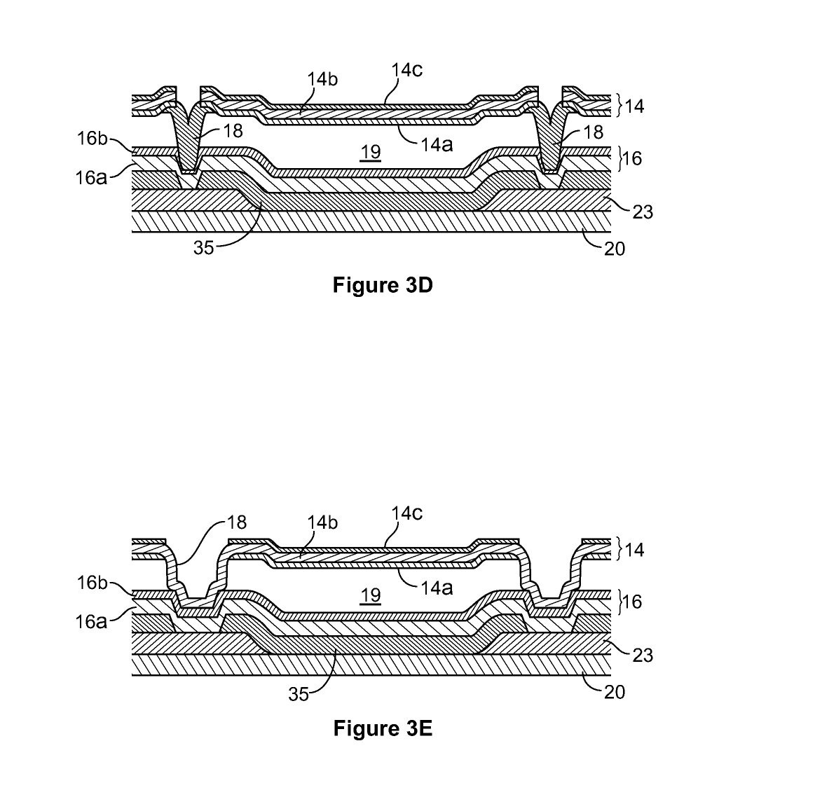

The details of the structure of interferometric modulators that operate in accordance with the principles set forth above may vary widely. For example, FIGS. 3A-3E show examples of cross-sections of varying implementations of interferometric modulators, including the movable reflective layer 14 and its supporting structures. FIG. 3A shows an example of a partial cross-section of the interferometric modulator display of FIG. 1, where a strip of metal material, i.e., the movable reflective layer 14 is deposited on supports 18 extending orthogonally from the substrate 20. In FIG. 3B, the movable reflective layer 14 of each IMOD is generally square or rectangular in shape and attached to supports at or near the corners, on tethers 32. In FIG. 3C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as support posts. The implementation shown in FIG. 3C has additional benefits deriving from the decoupling of the optical functions of the movable reflective layer 14 from its mechanical functions, which are carried out by the deformable layer 34. This decoupling allows the structural design and materials used for the reflective layer 14 and those used for the deformable layer 34 to be optimized independently of one another.

FIG. 3D shows another example of an IMOD, where the movable reflective layer 14 includes a reflective sub-layer 14a. The movable reflective layer 14 rests on a support structure, such as support posts 18. The support posts 18 provide separation of the movable reflective layer 14 from the lower stationary electrode (i.e., part of the optical stack 16 in the illustrated IMOD) so that a gap 19 is formed between the movable reflective layer 14 and the optical stack 16, for example when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiON) or silicon dioxide (SiO₂). In some implementations, the support layer 14b can be a stack of layers, such as, for example, a SiO₂/SiON/SiO₂ tri-layer stack. Either or both of the reflective sub-layer 14a and the conductive layer 14c can include, e.g., an aluminum (Al) alloy with about 0.5% copper (Cu), or another reflective metallic material. Employing conductive layers 14a, 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 3D, some implementations also can include a black mask structure 23. The black mask structure 23 can be formed in optically inactive regions (e.g., between pixels or under posts 18) to absorb ambient or stray light. The black mask structure 23 also can improve the optical properties of a display device by inhibiting light from being reflected from or transmitted through inactive portions of the display, thereby increasing the contrast ratio. Additionally, the black mask structure 23 can be conductive and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. For example, in some implementations, the black mask structure 23 includes a molybdenum-chromium (MoCr) layer that serves as an optical absorber, a layer, and an aluminum alloy that serves as a reflector and a bussing layer, with a thickness in the range of about 30-80 Å, 500-1000 Å, and 500-6000 Å, respectively. The one or more layers can be patterned using a variety of techniques, including photolithography and dry etching, including, for example, carbon tetrafluoride (CF₄) and/or oxygen (O₂) for the MoCr and SiO₂ layers and chlorine (Cl₂) and/or boron trichloride (BCl₃) for the aluminum alloy layer. In some implementations, the black mask 23 can be an etalon or interferometric stack structure. In such interferometric stack black mask structures 23, the conductive absorbers can be used to transmit or bus signals between lower, stationary electrodes in the optical stack 16 of each row or column. In some implementations, a spacer layer 35 can serve to generally electrically isolate the absorber layer 16a from the conductive layers in the black mask 23.

FIG. 3E shows another example of an IMOD, where the movable reflective layer 14 is self supporting. In contrast with FIG. 3D, the implementation of FIG. 3E does not include support posts 18. Instead, the movable reflective layer 14 contacts the underlying optical stack 16 at multiple locations, and the curvature of the movable reflective layer 14 provides sufficient support that the movable reflective layer 14 returns to the unactuated position of FIG. 3E when the voltage across the interferometric modulator is insufficient to cause actuation. The optical stack 16, which may contain a plurality of several different layers, is shown here for clarity including an optical absorber 16a, and a dielectric 16b. In some implementations, the optical absorber 16a may serve both as a fixed electrode and as a partially reflective layer.

In implementations such as those shown in FIGS. 3A-3E, the IMODs function as direct-view devices, in which images are viewed from the front side of the transparent substrate 20, i.e., the side opposite to that upon which the modulator is arranged. In these implementations, the back portions of the device (that is, any portion of the display device behind the movable reflective layer 14, including, for example, the deformable layer 34 illustrated in FIG. 3C) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing. Additionally, the implementations of FIGS. 3A-3E can simplify processing, such as, e.g., patterning.

Various implementations of the display devices, which can include interferometric modulator arrays, can rely on ambient lighting in daylight or well-lit environments for providing illumination to the display pixels. In some implementations, an internal source of illumination can be provided for illuminating the display pixels in dark ambient environments. In some implementations, the internal source of illumination can be provided by a front illuminator.

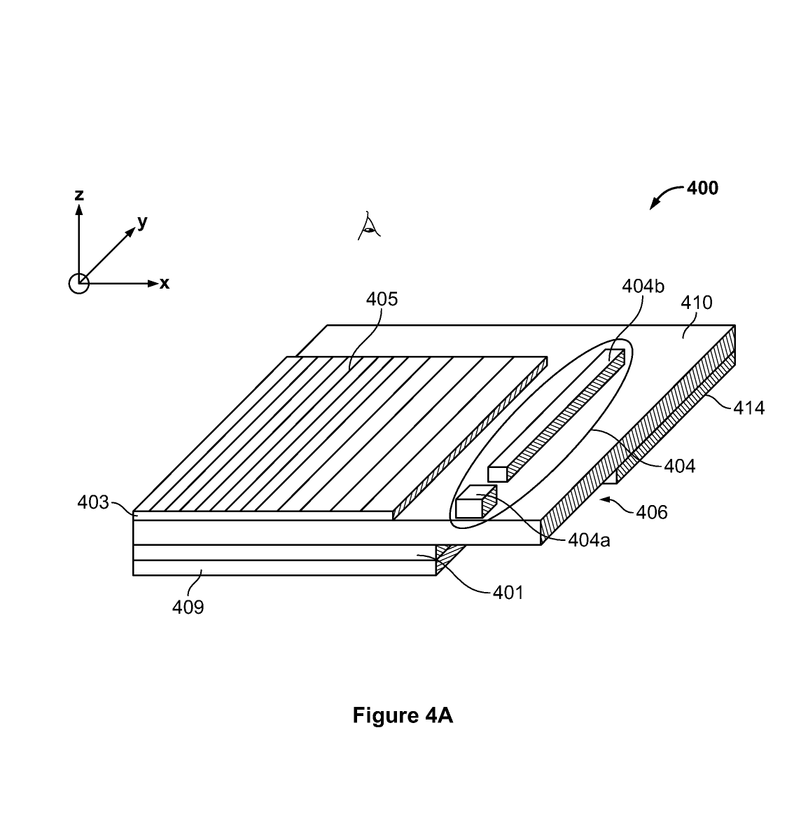

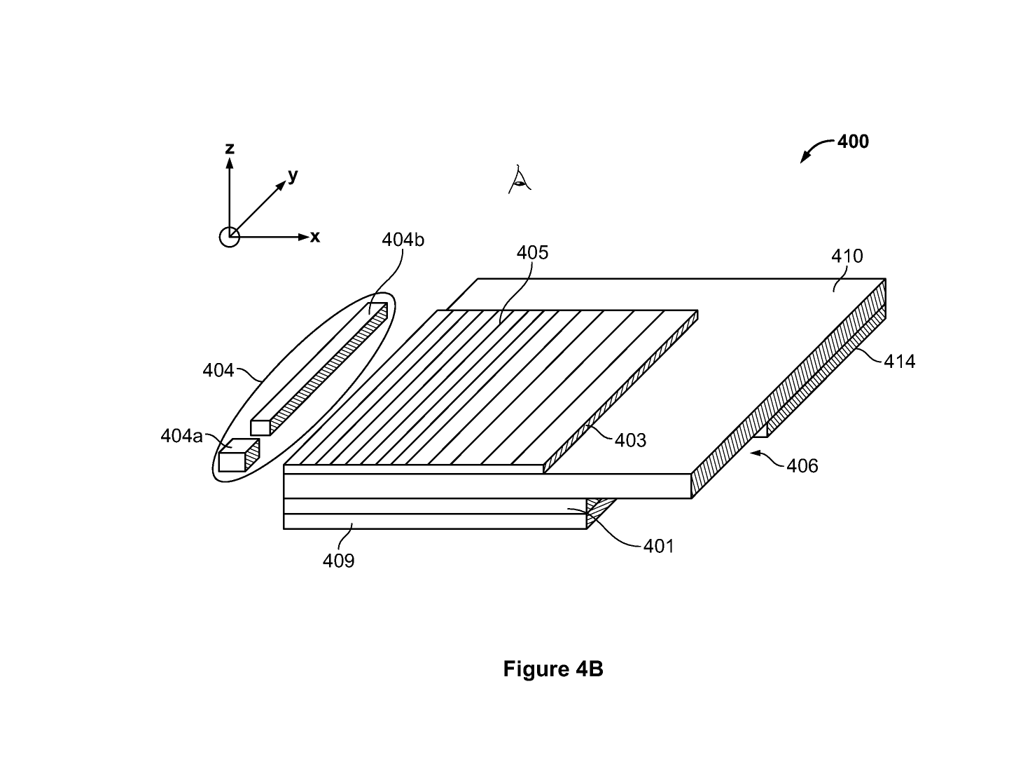

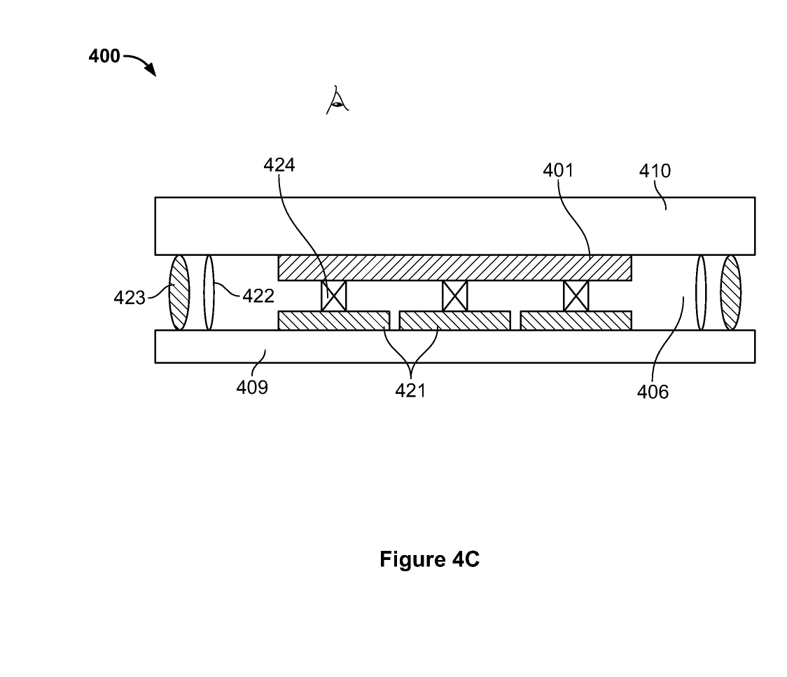

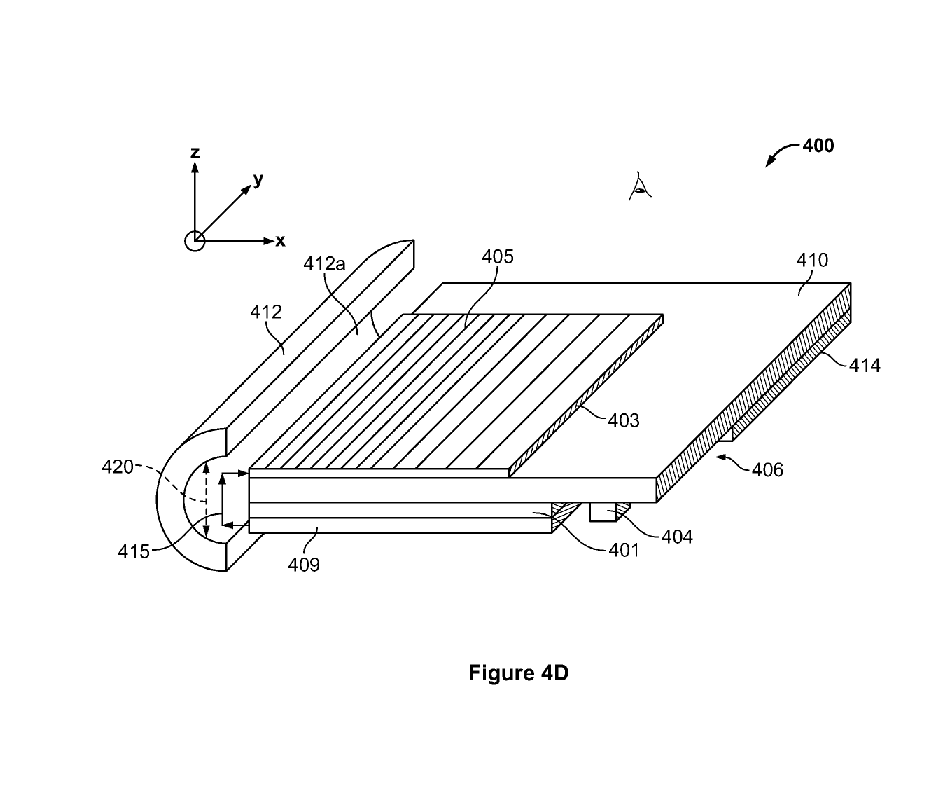

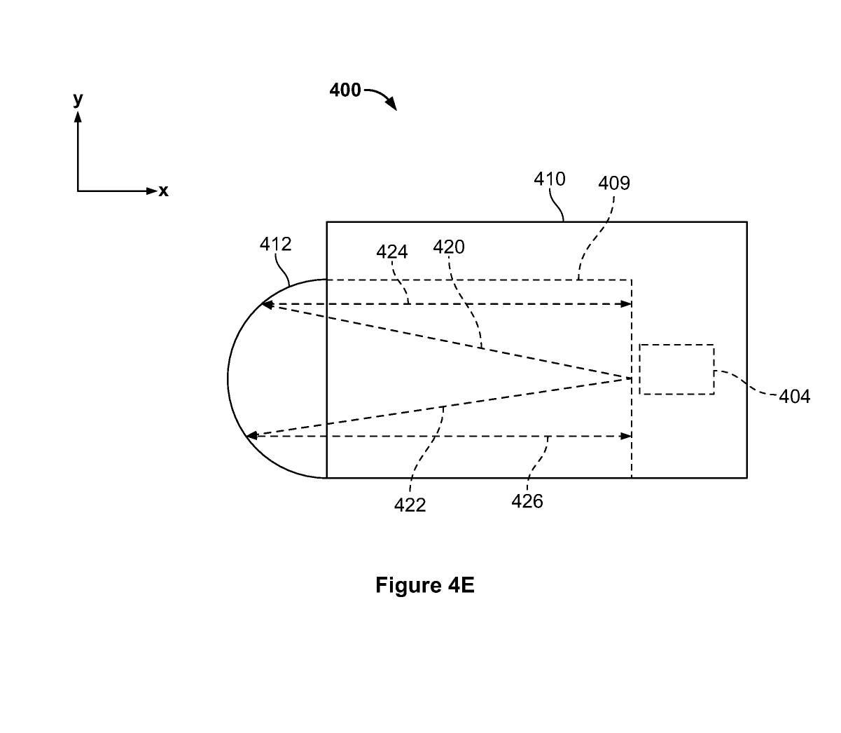

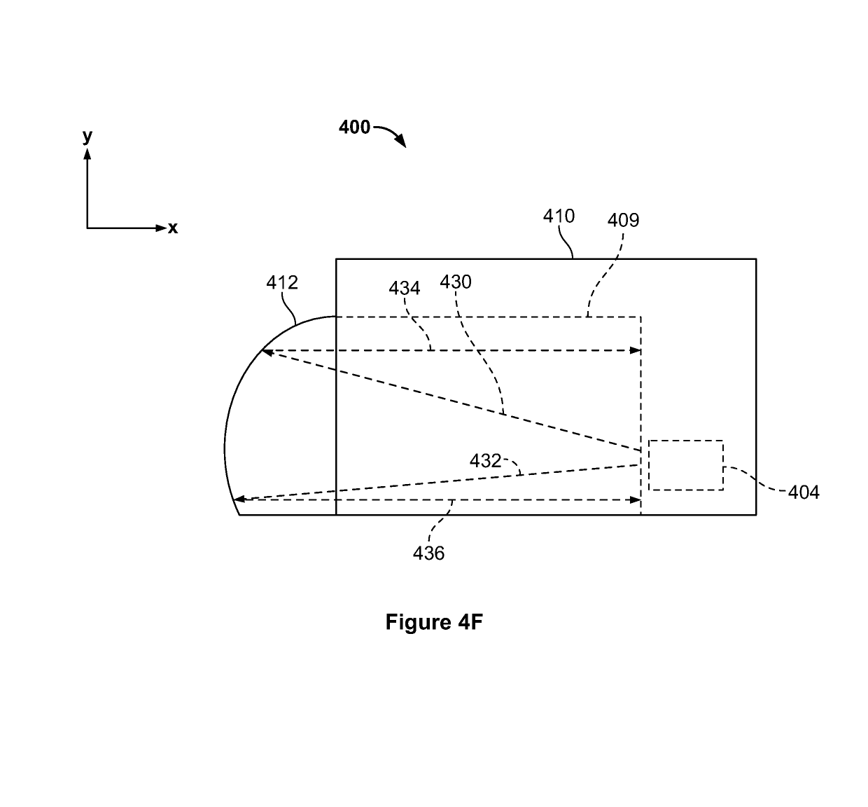

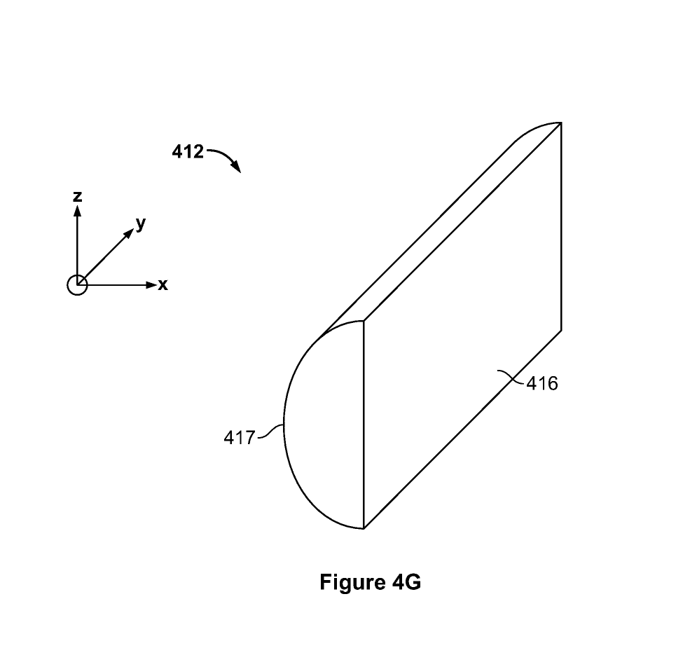

FIGS. 4A and 4B schematically illustrates a perspective view of two different implementations of a display device 400, which may include an array of interferometric modulators, further including a front illuminator. The display device 400 includes a plurality of light modulating elements 401 that are arranged to form a plurality of display pixels. The illustrated display device 400 further includes a display glass 410 and a front light guide 403 both disposed forward of the plurality of light modulating elements 401, a light source 404 including a light emitter 404a and a light bar 404b, a display backplate 409 disposed rearward of the plurality of light modulating elements 401 and driver electronics 414 configured to drive the plurality of light modulating elements 401. In the implementation illustrated in FIG. 4A, the front light guide 403 is disposed forward of the display glass 410. However, in other implementations, the display glass 410 can be disposed forward of the front light guide 403. In yet other implementations, the display glass 410 can function as the front light guide 403. Alternately, the front light guide 403 can be the display glass 410. The front light guide 403 and the display glass 410 can have forward and rearward surfaces. As illustrated in FIG. 4A, the display device is configured to be viewed through the forward surface of the front light guide 403 and/or the forward surface of the display glass 410.

The plurality of light modulating elements 401 can be reflective and in various implementations can include interferometric modulators. In various implementations, the light modulating elements 401 can be formed on the display glass 410. The display glass 410 can provide structural support during and after fabrication of the plurality of light modulating elements thereon. The plurality of light modulating elements 401 may be provided on a rearward surface of the display glass 410, such that the display image formed by the plurality of light modulating elements 401 is directed to a viewer through a forward surface of the display glass 410. In such implementations, the display glass 410 can include material that is substantially transmissive to light. The display glass 410 may extend beyond the extent of the plurality of light modulating elements 401. The portion of the display glass 410 that extends beyond the extent of the plurality of light modulating elements 401 can be referred to as a display ledge 406. In various implementations, driver electronics 414 can be disposed on the portion of the display ledge 406 proximal to the rearward surface of the display glass 410. The thickness of the display glass 410 can be in the range 0.1 mm to 1.0 mm.

The forward and rearward surfaces of the front light guide 403 can extend in longitudinal (x) and transverse (y) directions and have a thickness therebetween extending in the z-direction. In some implementations, the thickness of the front light guide 403 can be in the range of approximately 0.2 mm to approximately 1.5 mm. The front light guide 403 can include a plurality of edges between the forward and the rearward surfaces. Although a planar front light guide having the forward and rearward surface substantially parallel to each other is illustrated in FIG. 4A, the front light guide 403 can have any other geometry, for example, a wedge shape. The front light guide 403 can include optically transmissive material such as glass or plastic. In various implementations, the light guide 403 can be rigid or flexible. In various implementations, the front light guide 403 can be adhered to the plurality of light modulating elements 401 or the display glass 410 using a low refractive index adhesive layer such as pressure sensitive adhesive (PSA). The front light guide 403 can be provided with a plurality of turning features 405 on the forward or rearward surface of the front light guide 403. In various implementations, the plurality of turning features 405 can include elongate grooves, linear v-grooves, prismatic features, diffractive features forming one or more diffractive optical element(s), volume or surface holographic features and/or linear or curvilinear facets. In various implementations, the plurality of turning features 405 can be arranged linearly or along curved paths on the forward surface of the front light guide 403. The turning features 405 can be formed by a variety of methods such as embossing, or etching. Other methods for forming the turning features 405 can also be used. In some implementations, the turning features 405 can be formed or disposed on or in the front light guide 403 or on or in a film that forms a part of the front light guide 403 and maybe adhered to a surface of a front light guiding plate (for example, by lamination, by PSA, etc.).

The light source 404 including a light emitter 404a and a light bar 404b is disposed with respect to an edge of the front light guide 403 such that light from the light source 404 is injected into the edge of the front light guide 403. The light emitter 404a can include one or more light emitting diodes (LEDs), one or more lasers, one or more cold cathode light source, one or more fluorescent lamps, or other types of emitters. In the implementations illustrated in FIGS. 4A and 4B, light from the light emitter 404a is injected into the light bar 404b. The light bar 404b can be provided with light extractors, that direct light propagating within the light bar 404 towards the edge of the front light guide 403 that is proximal to the light bar 404b. Although an arrangement of a light emitter 404a and a light bar 404b is illustrated in FIGS. 4A and 4B, the source of illumination 404 can include an edge light such as one or more LEDs disposed with respect to an edge of the light guide to inject light therein. In some implementations, the light source 404 can be disposed forward of the plurality of light modulating elements 401 on the display ledge 406 as illustrated in FIG. 4A. In some implementations, the light source 404 can be disposed forward of the plurality of light modulating elements 401 on a side of the display device as illustrated in FIG. 4B.

Light injected from the light source 404 propagates through the front light guide 403 by multiple total internal reflections from the forward and rearward surfaces of the front light guide 403. The propagation of the light within the front light guide 403 is disrupted when the propagating light strikes the turning features 405 which are configured to redirect the propagating light out of the front light guide 403 towards the plurality of display elements 401.

FIG. 4C schematically illustrates an implementation of the display backplate 409 including components 421, one or more spacers 422, sealant 423 and interconnects 424. In various implementations, the components 421 can include electrical circuit components, optical components or mechanical components. In some implementations, components 421 can include a desiccant configured to provide a controlled environment to the plurality of light modulating elements 401. In various implementations, the sealant 423 can include an epoxy resin, a glass frit or a eutectic sealant. The display backplate 409 is disposed rearward of the plurality of display elements 401 and spaced apart from the display glass 410 to provide a cavity in which the plurality of light modulating elements 401 can be housed. The cavity can be provided by spacing the backplate 409 apart from the display glass 410 by spacers 422 disposed around the edge of the display glass 410 and/or the backplate 409 as shown in FIG. 4C or by recessing the display glass 410 and/or the backplate 409. The backplate 409 is attached to the display glass 410 with the sealant 423. The sealant 423 can provide a hermetic or a non-hermetic seal. Accordingly, the backplate 409 can provide mechanical protection from impact and/or provide a controlled environment for the plurality of light modulating elements 401 to insulate the plurality of light modulating elements 401 from external environmental factors such as heat or moisture that can adversely affect the performance of and/or reduce the lifetime of the plurality of light modulating elements 401. In some implementations, the display backplate 409 can be a part of a packaging of the display device 400.

In various implementations, the display backplate 409 can be an integral part of the display device 400. In some implementations, the backplate 409 maybe a functional component of the display device 400 in addition to providing protection to the plurality of light modulating elements 401. For example, components 421 such as thin film transistors (TFTs) can be disposed on the backplate 409 to control the plurality of light modulating elements 401 as shown in FIG. 4C. In various implementations, the components 421 may be connected to the plurality of light modulating elements 401 by interconnects 424 as shown in FIG. 4C.

The backplate 409 can be rigid or flexible. In some implementations, the thickness of the backplate can be between 0.2 mm and 1.5 mm. The display backplate 409 can include material that is transmissive to visible and/or infrared light such that visible and/or infrared light can be guided through the backplate. The display backplate 409 can include components, for example, switches and drivers that can facilitate the operation of the plurality of light modulating elements 401. In implementations, where electrical or optical components are disposed on the backplate 409, a cladding layer or an isolation layer may be provided between the backplate 409 and the plurality of light modulating elements 401 or components, 421, to confine and guide light through the backplate 409. The cladding layer or the isolation layer can include a material having lower refractive index than the material of the backplate 409. In various implementations, the display backplate 409 can be an integral part of the display device 400 and the display device 400 can be configured to be inoperative in the absence of the display backplate 409. In various implementations, the display backplate 409 can be mounted on the plurality of light modulating elements 401. In various implementations, the display backplate 409 and the plurality of light modulating elements 401 can be assembled in a frame.

As discussed above and illustrated in FIGS. 4A and 4B, the light source can be positioned forward of the plurality of light modulating elements 401 or disposed on a side of the display device and thus can add to the thickness or the width of the display device 400. In some implementations, it would be desirable to move the light source 404 rearward of the display glass 410 and/or the plurality of light modulating elements 401 and dispose the light source 404 on the display ledge 406 such that the light source 404 is proximal to an edge of the display backplate 409. This configuration can allow for more efficient utilization of the space available on the display ledge 406 and provide a compact display device. Light from the light emitter 404a can be coupled into the front light guide by using a smaller light redirector 412, as shown in FIG. 4D. In various implementations, the light redirector 412 can be, for example, a turning mirror or a light pipe. Removing the light emitter 404a and the light bar 404 from above the plurality of light modulating elements 401 can reduce the footprint of the display device 400 by reducing the height and/or the width of the display device 400. Moreover, in some implementations, the light bar 404b need not be included thereby reducing device complexity and possible cost. Such designs may be useful in addressing the size or form factor restrictions or other considerations. Various approaches described herein may therefore use a light source rearward of the display glass and/or the plurality of light modulating elements and a light redirector to front illuminate a reflective display element.

FIG. 4D schematically illustrates a perspective view of an implementation of a display device 400, which may include an array of interferometric modulators, further including a light redirector 412. In the implementation of the display device 400 illustrated in FIG. 4D, the light source 404 is disposed on the portion of the display ledge 406 proximal to the rearward surface of the display glass 410 such that light from the light source 404 can be injected into an edge of the backplate 409. The backplate 409 is configured to guide the injected light by multiple total internal reflections along the −x-direction and direct the light from the light source 404 towards the light redirector 412. The light redirector 412 can raise the light from the backplate to a level above the display glass 410 by a function similar to a periscope and inject the light into an edge of the front light guide 403 to provide front illumination to the plurality of light modulating elements as shown by the rays 415.

The light redirector 412 can include a turning mirror including a reflective surface 412a and an optical aperture 420. Alternately, the light redirector 412 can include a light pipe. The light redirector 412 can be curved in the vertical (z) and the longitudinal (x) directions. The light redirector 412 can also be curved in the longitudinal (x) and transverse (y) directions such that the curvature of the light redirector 412 is visible when the display device 400 is viewed from the front side. The curve can have a shape that is circular, parabolic, or aspheric, for example, elliptical, other conics or other shapes. The shape of the light redirector 412 can be selected according to the position of the light source with respect to the edge of the display backplate 409. For example, as shown in FIG. 4E, light (for example, rays 420 and 422) from a light source 404 that is centered with respect to the edge of the display backplate 409 can be efficiently turned by a light redirector 412 that is symmetric about a central axis of the display backplate 409 such that the turned light propagates along a direction normal to the edge of the backplate 409 as indicated by light rays 424 and 426. Examples of a symmetric light redirector 412 include a symmetric parabolic mirror, a symmetric elliptical mirror, etc. As another example, as shown in FIG. 4F, light (for example, rays 430 and 432) from a light source 404 that is offset with respect to the edge of the display backplate 409 can be efficiently turned by a light redirector 412 that is asymmetric about a central axis of the display backplate 409 such that the turned light propagates along a direction normal to the edge of the backplate 409 as indicated by light rays 434 and 436. The focus of the asymmetric light redirector 412 is also offset with respect to the edge of the backplate 409. Examples of an asymmetric light redirector 412 include an asymmetric parabolic mirror, an asymmetric elliptical mirror, etc. In various implementations, the light redirector 412 can include an asymmetric parabolic mirror. The reflective surface 412a of the light redirector 412 can be smooth or facetted. The facets can be planar or non-planar. The reflective surface 412a of the light redirector 412 can be multifaceted including, for example, three, four, five, ten or more facets. The reflective surface 412a may be metalized or have a dielectric or interference coating formed thereon. In various implementations, the light redirector 412 can include metal with one of the curved surfaces being polished to increase reflectivity. The light redirector 412 can envelop the display backplate 409 and the front light guide 403. In some implementations, the light redirector 412 can extend above the front light guide 403 and/or below the backplate 409. The optical aperture 420 of the light redirector 412 can correspond to the opening of the light redirector 412 that can capture light and can be greater than or equal to a combined thickness of the display glass 410, the front light guide 403, the plurality of light modulating elements 401 and the backplate 409. In implementations where the light redirector 412 includes a light pipe, the optical aperture of the light redirector 412 can be approximately equal to the thickness of the backplate 409. The height of the light redirector 412 can vary depending on the components of the display device 400, the functional requirement of the light redirector 412 and on the type of the light redirector (for example, a turning mirror or a light pipe). Accordingly, in various implementations, the height of the light redirector 412 can be between 0.5 and 3.0 mm. In some implementations, the height of the light redirector 412 can be greater than or equal to a combined thickness of the display glass 410, the front light guide 403, the plurality of light modulating elements 401 and the backplate 409. In some implementations, height of the light redirector 412 can be between 0.25 and 1.0 mm. The height of the light redirector 412 can have other sizes.

FIG. 4E illustrates a light redirector 412 that can be used in a display device as shown in FIG. 4D, and in other implementations such as described herein. In various implementations, the light redirector 412 can include a solid optically transmissive medium as illustrated in FIG. 4E instead of a an open concave region as illustrated in FIG. 4D. The solid light redirector 412, for example, can include a substantially optically transmissive material such as glass or plastic with a first curved surface 417 and a second planar surface 416. The curved surface 417 can be curved in the longitudinal (x) and the transverse (y) directions. The curved surface 417 can also be curved in the vertical (z) and the longitudinal (x) directions. The planar surface 416 of the light redirector 412 can be flat and can be contacted with the edge of the backplate 409, the display glass 410, or the front light guide 403. The curved surface 417 can be coated with a reflective layer. In some implementations, the reflective layer may be metallic. Other reflective coatings including dielectric coating, interference coating, etc. may be used. Light enters the solid light redirector 412 through the second planar surface 416 and is reflected at the first curved surface 417. In various implementations, the light redirector can include a total internal reflecting element or a prism.

In various implementations, it may be desirable to include an optical touch screen with the display device 400 for touch purpose. The optical touch screen can enable an interactive and/or a user friendly display device. For example, in various implementations, the optical touch screen can enable a user to move an object (for example, a finger, a pen, a stylus, etc.) across the display system to perform functions such as, but not limited to, opening applications, scrolling up or down across a window, input information, etc. Implementations of display devices including optical touch screen can be used in a variety of electronics devices such as, but not limited to, mobile telephones, wireless devices, personal data assistants (PDAs), hand-held or portable computers, GPS receivers/navigators, cameras, MP3 players, camcorders, game consoles, wrist watches, clocks, calculators, television monitors, flat panel displays, computer monitors, auto displays (for example, odometer display, etc.), cockpit controls and/or displays, display of camera views (for example, display of a rear view camera in a vehicle), electronic photograph displays, etc.

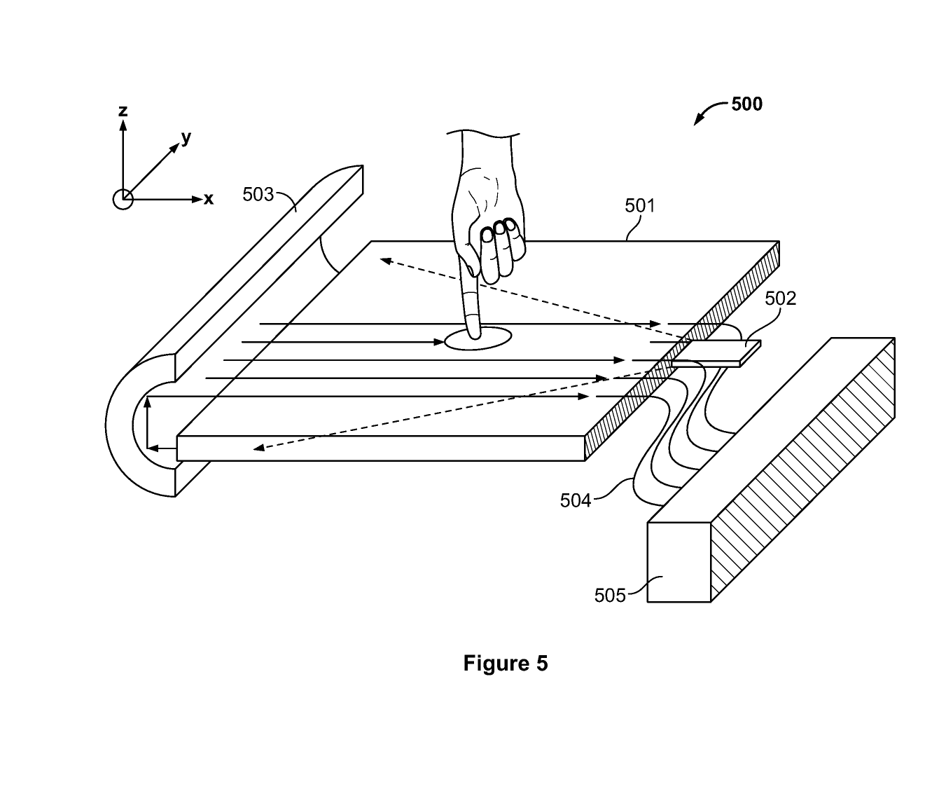

FIG. 5 schematically illustrates a perspective view of an implementation of an optical touch screen 500. In the illustrated implementation, the optical touch screen 500 includes a touch surface 501 having a forward surface and a rearward surface that extend in longitudinal (x) and transverse (y) directions and have a thickness therebetween extending in the z-direction. In some implementations, the thickness of the touch surface can be in the range 0.25 mm to 1.5 mm. In implementations, where the optical touch screen 500 is integrated with a display device, the optical touch surface 501 can be the display glass or the cover glass of the display device which provides protection to the display elements. In various implementations, the thickness of the optical touch surface 501 is chosen such that the optical touch surface 501 can guide light. The optical touch screen 500 further includes a light source 502 (for example, a LED, a light bar, an array of LEDs, etc.), a light redirector 503 (for example, an asymmetric parabolic reflector), a plurality of waveguide receivers 504 and a sensor array 505. The sensor array 505 can include individual sensors, or photo-detectors. The light source 502 is disposed to inject light into a first edge of the touch surface 501 that is proximal to the light source. The light redirector 503 is disposed proximal a second edge of the touch surface 501, the second edge being opposite the first edge. The plurality of waveguide receivers 504 can be disposed along the first edge of the touch surface 501. The plurality of waveguide receivers 504 can include optical fibers that are configured to direct the received light to one or more sensors. In various implementations, the light redirector 503 can be similar to the light redirector 412 discussed above.

The operation of the optical-touch screen 500 is described below. Light from the light source 502 is injected into the first edge of the touch surface 501 and propagates through the touch surface 501 as a divergent beam (as shown by the dashed lines). A portion of light that exits the touch surface 501 through the second edge opposite the first edge is redirected above the forward surface of the touch surface 501 by the light redirector 503 such that the redirected portion of light propagates forward of the front side of the touch surface 501 in a direction parallel to the x-axis. In various implementations, the light redirector 503 can be configured such that the redirected portion of the light is spread across the forward surface of the touch surface 501. In various implementations, the light redirector 503 can include an asymmetric parabolic mirror that can be configured to collimate the redirected light such that the redirected light has uniform flux across the forward surface of the touch surface 501. The plurality of waveguides 504 is configured to receive and direct portions of the light forming the light sheet to the sensor array 505. An object (for example, a pen, a finger, a stylus, etc.) that is placed on the touch surface will interrupt the propagation of certain rays of light that are included in the sheet of light and cause the corresponding sensors configured to detect those rays of light to exhibit a loss of signal or a reduction in the signal strength. The position of the obstructing object can be determined by identifying those sensors that exhibit the loss of signal or the reduction in the signal strength. Although, FIG. 5 illustrates a plurality of waveguides 504 configured to receive and direct portions of the light forming the light sheet to the sensor array 505, the plurality of the waveguides 504 can be eliminated by disposing the sensor array 505 forward of the touch surface 501 and along the first edge of the touch surface 501. Alternately, in various implementations, the sensor array 505 can be disposed rearward of the touch surface 501 and an additional light redirector disposed opposite the light redirector 503 and facing the light redirector 503 can be used to direct light propagating forward of the touch surface 501 rearward of the touch surface towards the sensor array 505 as described in other implementations herein.

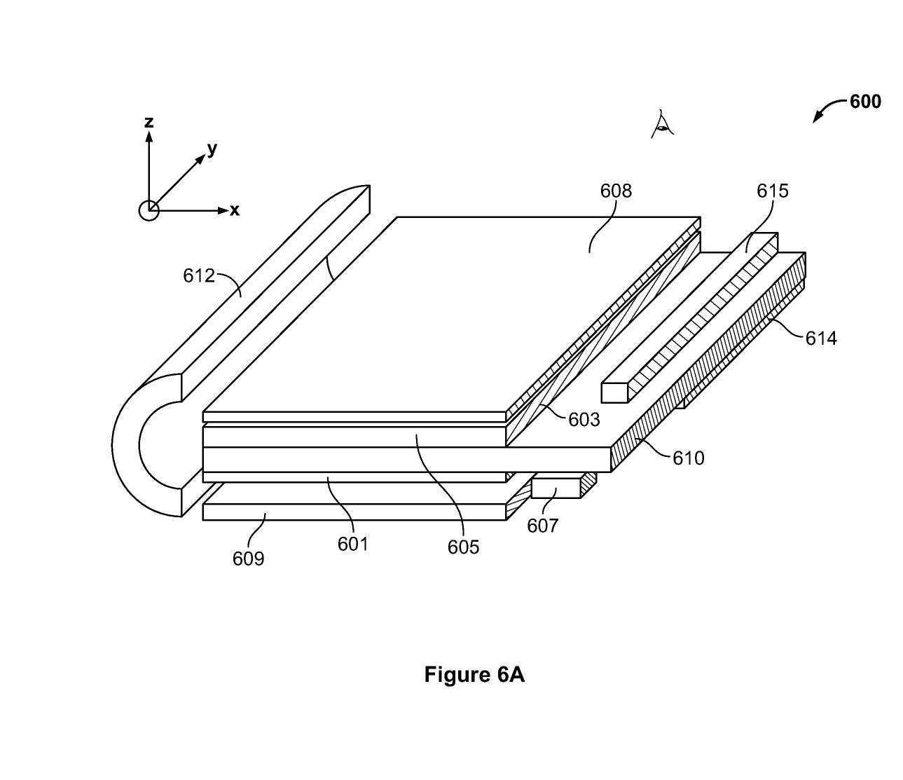

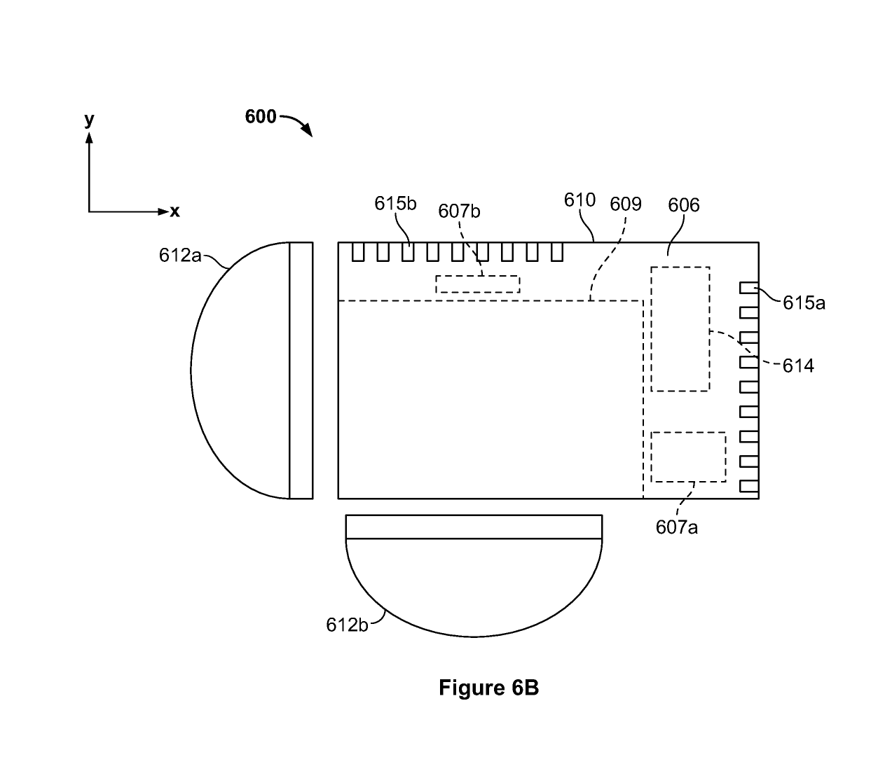

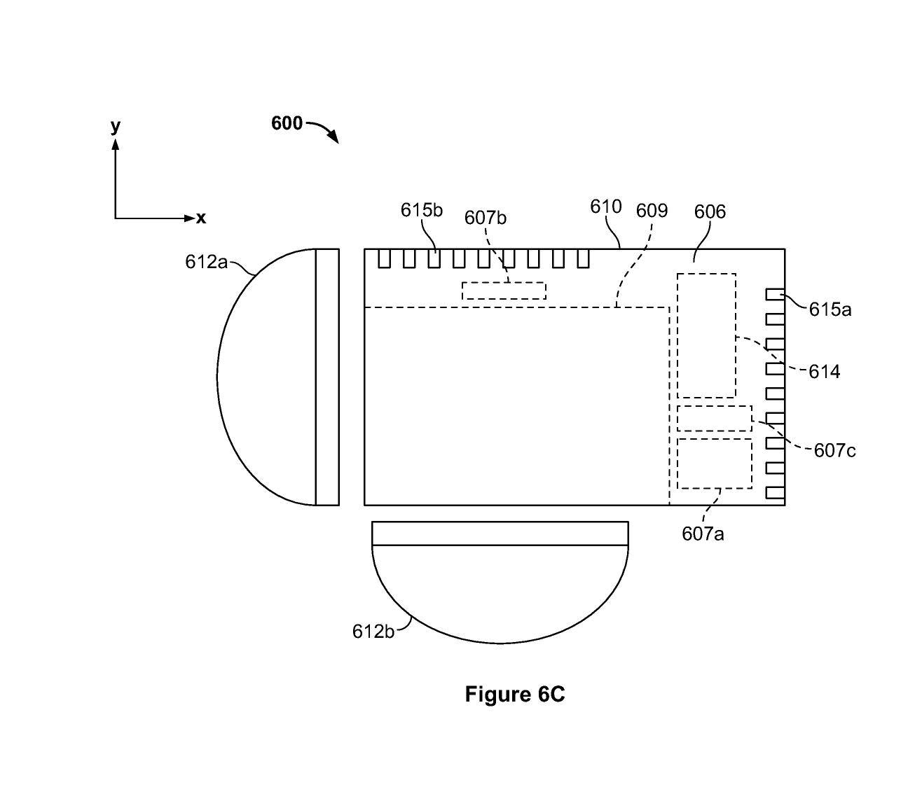

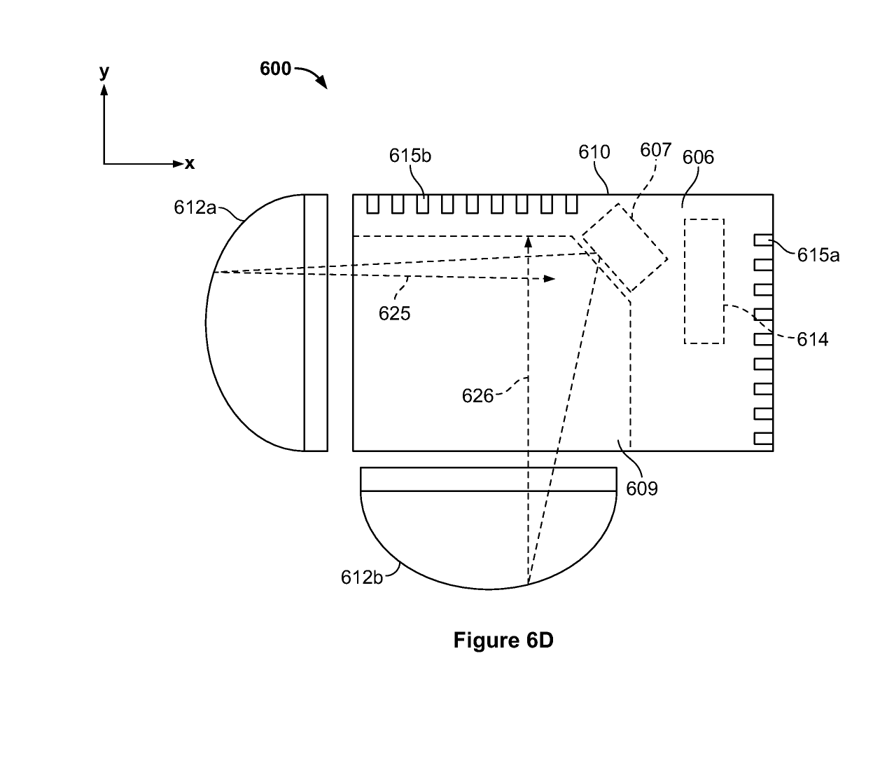

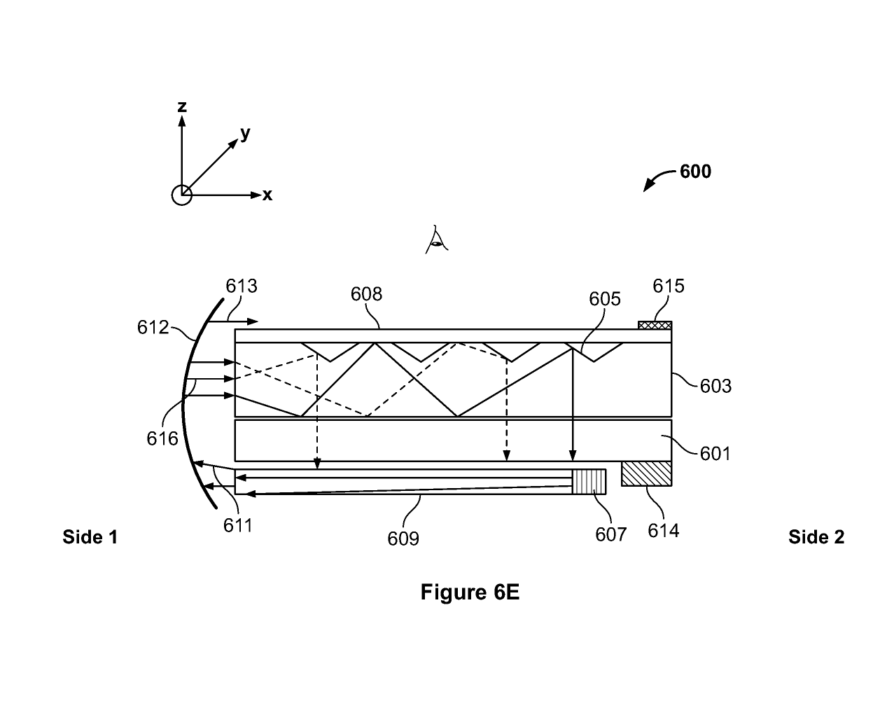

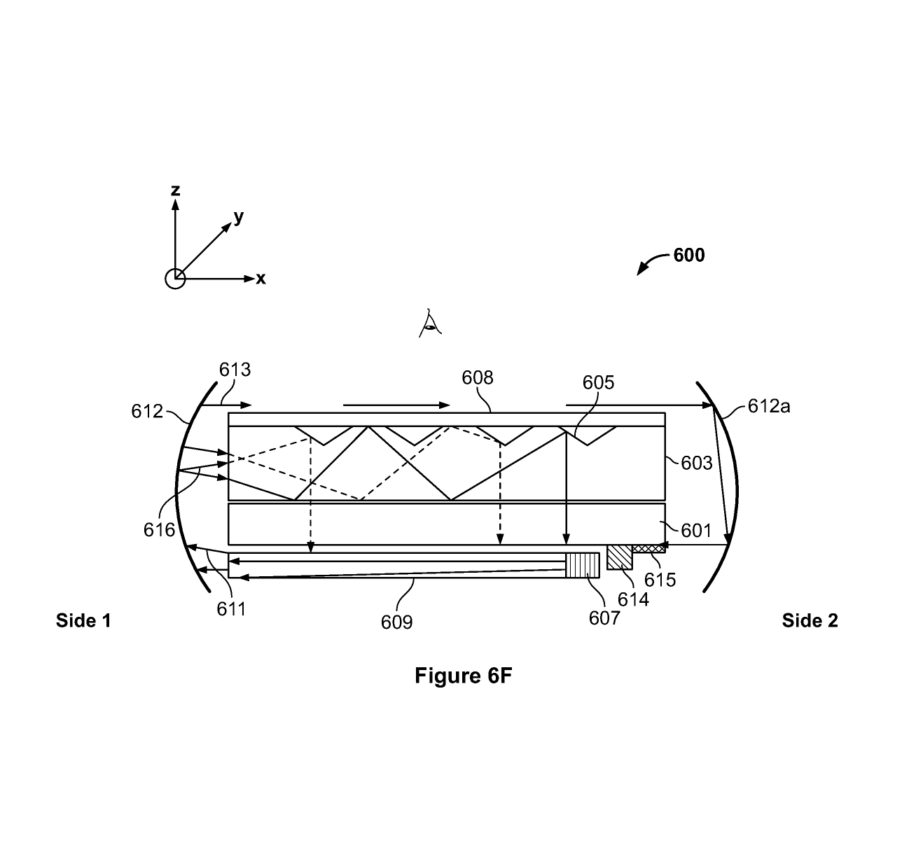

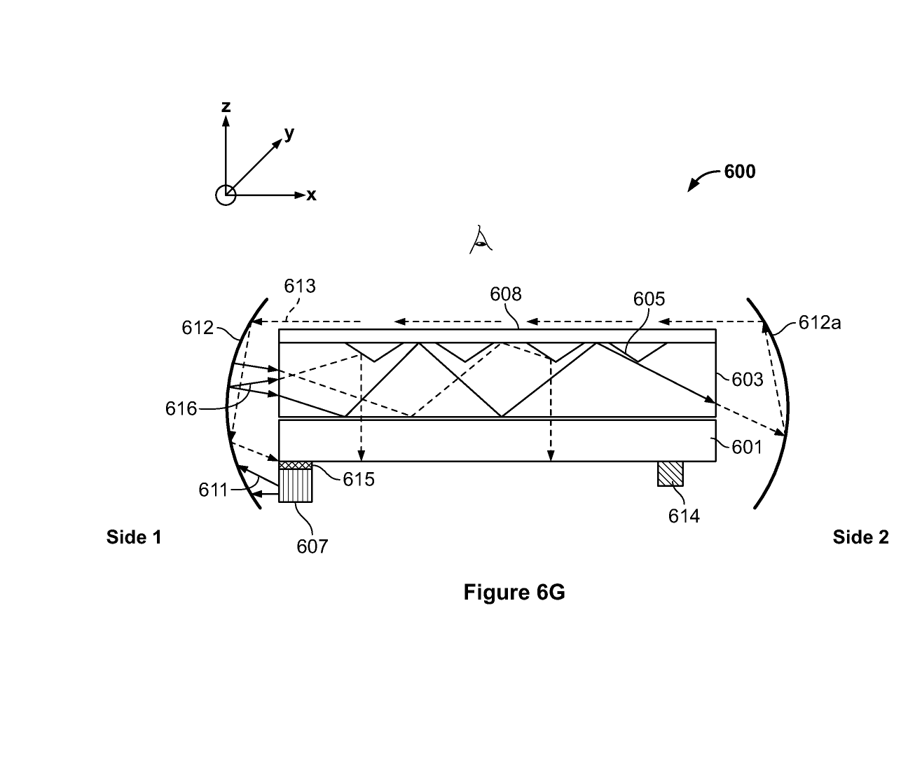

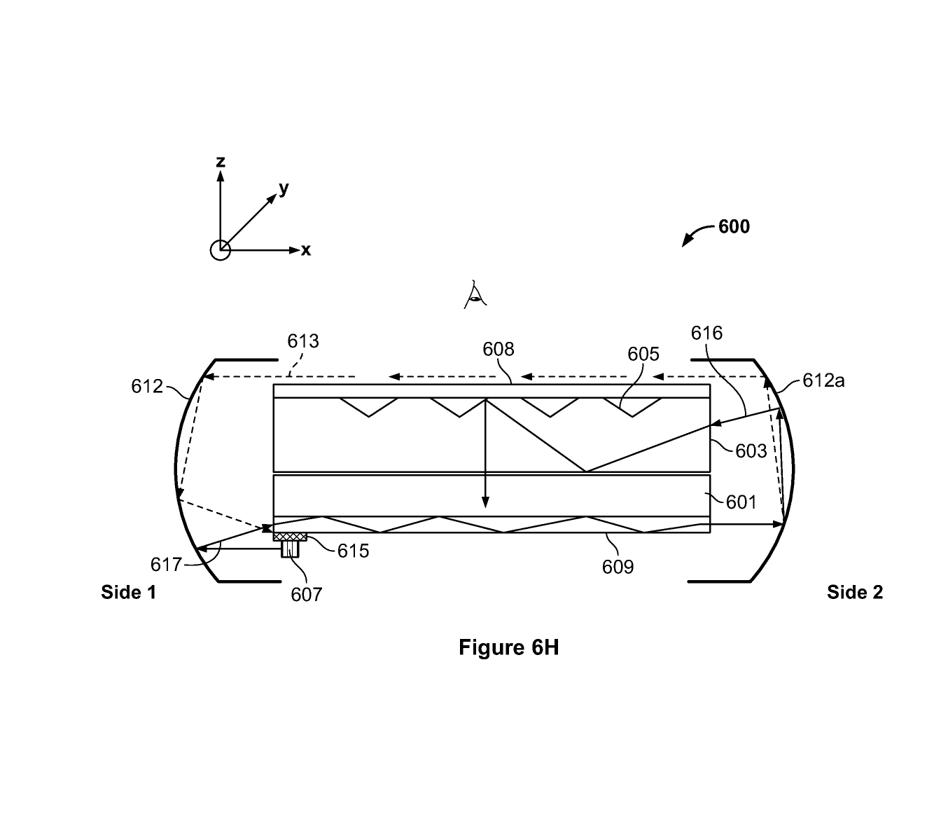

Although, FIG. 5 illustrates a light redirector 503 that redirects light forward of the touch surface 501 in a direction parallel to the x-axis, a second light redirector is provided to the optical touch screen 500 along a third edge of the touch surface 501, the third edge being adjacent the first and second edges as shown in FIGS. 6B-6D. With reference to FIG. 5, the light redirector 503 disposed along the third edge is configured to redirect light propagating through the touch surface 501 forward of the touch surface 501 in a direction parallel to the x-axis to create a light grid in the x-y plane to determine the position of the object or touch input. In various implementations, a second light source can be provided to inject light into a fourth edge of the touch surface 501, the fourth edge of the touch surface being opposite the third edge. A plurality of waveguides or sensors can be provided along the fourth edge to sense the light propagating in a direction parallel to the y-axis.

Various implementations described below, discuss possible ways of combining an optical touch screen with a display device.

FIG. 6A schematically illustrates a perspective view of an implementation of a display device 600 having a front light guide and including an optical touch screen. The display device 600 includes a display touch surface 608, and a display glass 610. The display device 600 further includes a plurality of light modulating elements 601 rearward of the display glass 610. A front light guide 603 including a plurality of turning features 605 is disposed forward of the plurality of light modulating elements 601. The display device 600 further includes a source of illumination 607, a second light guide 609 disposed rearward of the plurality of light modulating element 601, a light redirector 612, driver electronics 614 and sensors or receiver waveguides 615. As illustrated in FIG. 6A, the display device is configured to be viewed through a forward surface of the display touch surface 608 and/or a forward surface of the display glass 610. In various implementations, the display glass 610 or the front light guide 603 can be configured as the display touch surface 608. In various implementations, the source of illumination 607 and the driver electronics 614 can be disposed on the display ledge 606 of the display device 600.

In various implementations, display glass 610 can be similar to the display glass 410 discussed above and the light modulating elements 601 can be similar to the light modulating elements 401 described above. The plurality of light modulating elements 601 can be reflective and can include interferometric modulators. In various implementations, the front light guide 603 can be similar to the front light guide 403 described above and the display touch surface 608 can be similar to the touch surface 501 described above. The sensors or receiver waveguides 615 can represent an array of sensors similar to the sensor array 505 or one or more receiver waveguides similar to receiver waveguides 504 discussed above.

In various implementations, the second light guide 609 can include a substrate that is positioned rearward of the plurality of display elements 601. The substrate can include circuitry that are used to drive the plurality of display elements 601. In some implementations, the substrate can be a backplate of the display device 600 similar to the backplate 409 discussed above. In some implementations, the substrate can be a backplane of the display device 600 that includes driver electronics or thin film transistors (TFTs) that drive the plurality of light modulating elements 601. In some implementations, the substrate can provide structural support to the plurality of display elements 601 and/or protect the plurality of light modulating elements 601 from the environment. In some implementations, the substrate may include electrical or mechanical components that are configured to render the plurality of light modulating elements 601 inoperative in the absence of the substrate. In various implementations, a cladding layer including a material having a refractive index lower than the refractive index of the material of the second light guide 609 can be disposed between the second light guide 609 and the plurality of display elements 601 to increase the confinement of the light in the second light guide 609.

In various implementations, the source of illumination 607 can include one or more light emitting diodes, a laser array or a light bar. As illustrated in FIG. 6A, the source of illumination 607 is disposed rearward of the display glass 610 and/or the plurality of light modulating elements 601. In implementations where the second light guide 609 is the backplate of the display device, disposing the source of illumination 607 rearward of the display glass 610 and/or the plurality of light modulating elements 601 can allow for efficient use of the available space and reduces the amount of dead space in the display device 600, since the source of illumination 607 occupies a space that was previously not used.

In various implementations, the light redirector 612 can be similar to the light redirector 412 described above. The light redirector 612 can include one or more curved surfaces. In some implementations, the curved surfaces of the light redirector 612 can include cylindrical surfaces. In various implementations, the curved surfaces of the light redirector 612 can include parabolic or elliptical surfaces in the vertical (z), longitudinal (x) and/or the transverse (y) directions. In some implementations, the light redirector 612 can include a curved cross-section. The curved cross-section can be circular, elliptical, other conics or aspheric. For example, in some implementations, the light redirector 612 can include an asymmetric parabolic mirror that is curved in the longitudinal (x) and the transverse (y) directions such that light reflected by the asymmetric parabolic mirror is collimated in the x-y plane. The asymmetric parabolic mirror can also be curved in the vertical (z) and the longitudinal (x) direction. In some implementations, the light redirector 612 can include a metal or a dielectric. In certain implementations, the light redirector 612 can include a partially reflecting surface coated with a reflecting layer (for example, metal or a dielectric). The reflecting layer can include a metallic coating, a dielectric coating, an interference coating, etc. In some implementations, the light redirector 612 can include an optical element configured to reflect light via total internal reflection. In some implementations, the light redirector 612 may be an asymmetric parabolic reflector or a parabolic shaped light pipe.

As illustrated in FIG. 6A, the light redirector 612 is disposed proximal to an edge of the front light guide 603 and/or an edge of the second light guide 609. The light redirector 612 has an optical aperture that overlaps with an edge of the second light guide 609, the front light guide 603, the display glass 610 and/or the display touch surface 608. In various implementations, the optical aperture of the light redirector 612 can extend below the second light guide 609 and above the display touch surface 608. Light from the source of illumination 607 is injected into an edge of the second light guide 609 that is proximal to the source of illumination 607. The injected light propagates through the second light guide 609 and is incident on the light redirector 612. The light redirector 612 turns the incident light upwards and redirects the incident light along the +x-direction. A portion of the redirected light may be injected into the front light guide 603 for front illumination and another portion can be directed forward of the display touch surface 608 for optical touch purpose.

FIGS. 6B-6D schematically illustrate the top view of three different implementations of a display device 600 with combined front illumination and optical touch screen. The implementation illustrated in FIG. 6B includes two sources of illumination 607a and 607b, two light redirectors 612a and 612b and two sensor arrays 615a and 615b. In various implementations, the two light redirectors 612a and 612b can be joined together to form a combined light redirector. In various implementations, light redirectors may be provided along each edge of the second light 609. In various implementations one, two, three or four of the light redirectors may be joined together to form an annular light redirector. The source of illumination 607a is disposed on the display ledge 606 rearward of the display glass 610 and proximal to a first edge of the second light guide 609 and the source of illumination 607b is disposed on the display ledge 606 rearward of the display glass 610 and proximal to a second edge of the second light guide 609. Light redirector 612a is disposed proximal to a third edge of the second light guide 609 which is opposite the first edge, and light redirector 612b is disposed proximal to a fourth edge of the second light guide 609 which is opposite the second edge. Sensor arrays 615a and 615b are disposed forward of the display glass 610.

Light from the source of illumination 607a can be injected into the second light guide 609 such that it propagates along the −x-direction and is turned by the light redirector 612a and directed forward of the second light guide 609 towards the sensor array 615a to provide optical touch function. In some implementations a portion of the light redirected by the light redirector 612a can be used to provide front illumination to the plurality of display elements 601 (not shown in the top view). Light from the source of illumination 607b can be injected into the second light guide 609 such that it propagates along the −y-direction and is turned by the light redirector 612b and directed forward of the of the second light guide 609 towards the sensor array 615b to provide optical touch function. In some implementations a portion of the light redirected by the light redirector 612b can be used to provide front illumination to the plurality of display elements 601 (not shown in the top view).

The implementation illustrated in FIG. 6C includes three sources of illumination 607a, 607b and 607c. The sources of illumination 607a and 607c are disposed on the display ledge 606 rearward of the display glass 610 and proximal to a first edge of the second light guide 609. The source of illumination 607b is disposed on the display ledge 606 rearward of the display glass 610 and proximal to a second edge of the second light guide 609. Light redirector 612a is disposed proximal to a third edge of the second light guide 609 which is opposite the first edge, and light redirector 612b is disposed proximal to a fourth edge of the second light guide 609 which is opposite the second edge.

In the implementation, illustrated in FIG. 6C, sources of illumination 607a and 607b are configured to emit light in infrared spectral region while source of illumination 607c is configured to emit light in the visible spectral region. Light from the sources of illumination 607a and 607b that is injected into the second light guide 609 is turned by the light redirectors 612a and 612b forward of the second light 609 towards sensor arrays 615a and 615b for optical touch purpose. The light redirector 612a is further configured to redirect light from the source of illumination 607c forward of the second light guide 609 and inject the redirected light into the front light guide 603 (not shown in the top view) to provide front illumination to the plurality of light modulating elements 601 (not shown in the top view). In various implementations, the two sources of illumination 607a and 607c can emit light in the same spectral region but have different spectral bandwidths and/or wavelengths.

The implementation illustrated in FIG. 6D includes one source of illumination 607 that is disposed to illuminate the third and the fourth edge of the second light guide 609 simultaneously such that light redirected by light redirectors disposed along the third and the fourth edge of the second light guide 609 can be detected by sensors disposed opposite the third and the fourth edges for optical touch purpose. In various implementations, the third and the fourth edge intersect each other at an angle (for example, 90 degrees, as shown in FIG. 6D). In some implementations, simultaneous illumination of two edges intersecting each other at an angle can be achieved by disposing the source of illumination 607 at a corner of the second light guide 609 as shown in FIG. 6D. Light from the source of illumination 607 propagates through the second light guide 609 towards both the light redirectors 612a and 612b. Light incident on light redirector 612a is directed forward of the second light guide 609 and propagates in a direction parallel to the x-axis towards sensor array 615a, while light incident on light redirector 612b is directed forward of the second light guide 609 and propagates in a direction parallel to the y-axis towards sensor array 615b. Using a single source of illumination 607 as illustrated in FIG. 6D can save on component count and costs. The light redirectors 612a and 612b can be designed such that light incident on the light redirectors 612a and 612b at non-normal angles with respect to the third and fourth edge of the second light guide 609 and/or the entrance aperture of the light redirectors 612a and 612b are redirected such that the redirected light exits the light redirectors 612a and 612b at an angle normal to the third and fourth edge of the second light guide 609 and/or the entrance aperture of the light redirectors 612a and 612b as illustrated by rays 625 and 626 in FIG. 6D. This could be accomplished by using optical components such as prismatic array at the interface of the second light 609 and the light redirectors 612a and 612b such that light is incident on the light redirectors 612a and 612b at the appropriate angles. In some implementations, the light redirectors 612a and 612b can include facets or an aspheric surface such that light incident on reflecting surface of the light redirectors 612a and 612b at non-normal angles with respect to the third and fourth edge of the second light guide 609 and/or the entrance aperture of the light redirectors 612a and 612b are reflected along the normal to the third and fourth edge of the second light guide 609 and/or the entrance aperture of the light redirectors 612a and 612b. In FIGS. 6B-6D, the sensor arrays 615a and 615b can be replaced by waveguides that are connected to one or more sensors.

FIGS. 6E-6H illustrate cross-sectional views of various implementations of a display device 600 including an optical touch screen and a front light guide for illumination wherein light from a source of illumination 607 is used both for providing front illumination to the light modulating elements 601 and for optical touch purpose. The implementation of the display device 600 illustrated in FIG. 6E includes a display touch surface 608 and a front light guide 603 including a plurality of turning features 605 disposed rearward of the display touch surface 608. The display device 600 illustrated in FIG. 6E further includes a plurality of light modulating elements 601 disposed rearward of the front light guide 603 and a source of illumination 607 disposed rearward of the plurality of light modulating elements 601 on a second side (side 2) of the display device 600. A second light guide 609 is provided rearward of the plurality of light modulating elements 601. A light redirector 612 is disposed on a first side (side 1) of the display device 600. The light redirector 612 overlaps with an edge of the display touch surface 608, front light guide 603 and the second light guide 609. Driver electronics 614 configured to drive the plurality of light modulating elements 601 is disposed on the second side (side 2) of the display device 600. The display device 600 further includes one or more sensors that are disposed on the second side (side 2) or receiver waveguides 615 coupled to one or more sensors. As illustrated in FIG. 6A, the display device is configured to be viewed through the front surface of the display touch surface 608.

In the implementation of the display device 600 illustrated in FIG. 6E, light from the light source 607 is injected into a first edge on the second side (side 2) of the second light 609 such that light propagates through the second light guide along the −x-direction towards a second edge of the second light guide 609 on the first side (side 1) of the display device 600. Light 611 that is ejected out of the second edge of the second light guide 609 is received by the light redirector 612, that is disposed proximal to the second edge of the second light guide 609 on the first side (side 1) of the display device 600, and is raised upward along the z-direction or forward of the plurality of light modulating elements 601 and then redirected along the +x-direction. A first portion 616 of the redirected light is injected into a first edge on the first side of the display device 600 of the front light guide 603 and a second portion of the redirected light 613 is directed forward of the display touch surface 608 towards the one or more sensors or receiver waveguides 615 for optical touch purpose. Light that is injected into the front light guide 603 propagates through the front light guide 603 by multiple total internal reflections along the +x-direction from the first side (side 1) of the display device 600 toward a second side (side 2) of the display device 600. The propagation of the light through the front light guide 603 is interrupted when light strikes the plurality of turning features 605 which are configured to direct the light out of the rearward surface of the front light 603 towards the plurality of light modulating elements 601.

In various implementations, the light redirector 612 can be designed such that the first and second portions are substantially collimated. For example, the light redirector 612 can include an asymmetric parabolic mirror having curved surface in the longitudinal (x) and the transverse (y) directions as shown in FIGS. 6B-6D such that light is collimated in the x-y plane. In various implementations, the angular divergence of the portions 613 and 616 can be less or equal to approximately 90 degrees (for example, 90 degrees, 60 degrees, 50 degrees, 40 degrees, etc.) in a plane parallel to the X-Y plane (along the surface of the front light guide 603 and the display touch surface 608) and in a plane parallel to the Y-Z plane. Collimating the first portion 616 before injecting into the front light guide 603 can reduce visual artifacts in the displayed image. Collimating the second portion 613 that is used for optical touch purpose can improve the spatial resolution provided by the optical touch screen.

The implementation of the display device 600 illustrated in FIG. 6F includes a second light redirector 612A that is disposed on the second side (side 2) of the display device 600 opposite the first side (side 1) of the display device 600 and the first light redirector 612. The second light redirector 612A can be similar to the first light redirector 612 and/or the light redirector 412 discussed above. The second light redirector 612A is configured to receive the second portion of light 613 that is propagating forward of the display touch surface 608 and lower the received light along the −z-direction and rearward of the plurality of light modulating elements 601 and redirect the received light towards the one or more sensors or waveguide receivers 615 which are disposed rearward of the plurality of light modulating elements 601. Disposing the sensors or waveguide receivers 615 rearward of the plurality of light modulating elements 601 can be advantageous in reducing the thickness and/or the footprint of the display device 600.

In the implementations illustrated in FIG. 6G, light from the light source 607 is directly incident on the first light redirector 612 and raised upwards along the +z-direction and forward of the plurality of light modulating elements 601 and injected into an edge of the front light guide 603 on the first side (side 1) of the display device 600. The injected light propagates through the front light guide 603 and a first portion of the propagating light is turned towards the plurality of light modulating elements 601 and a second portion is not turned towards the plurality of light modulating elements 601 and exits out of a second edge of the front light guide 603 on the second side (side 2) of the display device. The portion of the light injected into the front light guide 603 that is not turned towards the plurality of light modulating elements 601 and exits the front light guide 603 is further raised upwards along the +z-direction and forward of the front light guide 603 by the second light redirector 612A and redirected towards the first side of the display device 600 forward of the display touch surface 608 as shown by the light rays 613. In the illustrated implementation, the first light redirector 612 is also configured to receive and direct the light propagating forward of the display touch surface 608 towards one or more sensors or waveguide receivers 615 which is disposed rearward of the plurality of light modulating elements 601. Although, the implementation illustrated in FIG. 6G does not include a second light guide 609, other alternate implementations of FIG. 6G can include a second light 609.

In the implementation illustrated in FIG. 6H, the source of illumination 607 and the one or more sensors or receiver waveguides 615 are disposed rearward of the second light guide 609 on the first side (side 1) of the display device 600. Light from the source of illumination 607 is directly incident on the first light redirector 612 on the first side (side 1) of the display device 600 and redirected by the first light redirector 612 such that it is injected into the second light guide 609 as shown by the ray 617 and propagates through the second light guide 609 along the +x-direction from a first side (side 1) of the display device to a second side (side 2) of the display device. A second light redirector 612A is configured to receive light exiting the second light guide 609 on the second side (side 2) and raise the received light upwards along the +z-direction and forward of the plurality of light modulating elements 601 and inject a first portion of the received light 616 into an edge of the front light guide 603 at the second side (side 2) of the display device 603. The injected light propagates through the front light guide 603 from the second side (side 2) toward the first side (side 1) of the display device 600. A second portion of the light received by the second light redirector 612A is directed forward of the display touch surface 608 from the second side (side 2) toward the first side (side 1) of the display device 600 as shown by the light rays 613 for optical touch purpose. The first light redirector 612 can also be configured to receive and direct the light propagating forward of the display touch surface 608 towards the one or more sensors or waveguide receivers 615. The light redirector 612 and 612A illustrated in FIGS. 6E-6H can be portions of a combined light redirector or a system including additional light redirectors that can direct light forward of the display touch surface 608 along a direction parallel to the x-axis and a direction parallel to the y-axis for optical touch purpose and/or receive light propagating forward of the display touch surface 608 along a direction parallel to the x-axis and a direction parallel to the y-axis and direct the received light towards one or more sensors 615.

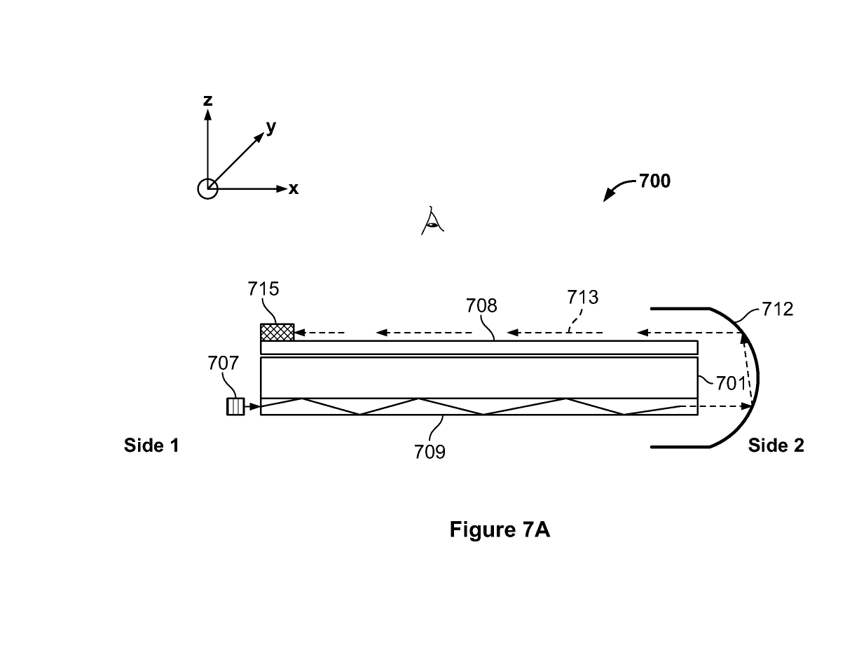

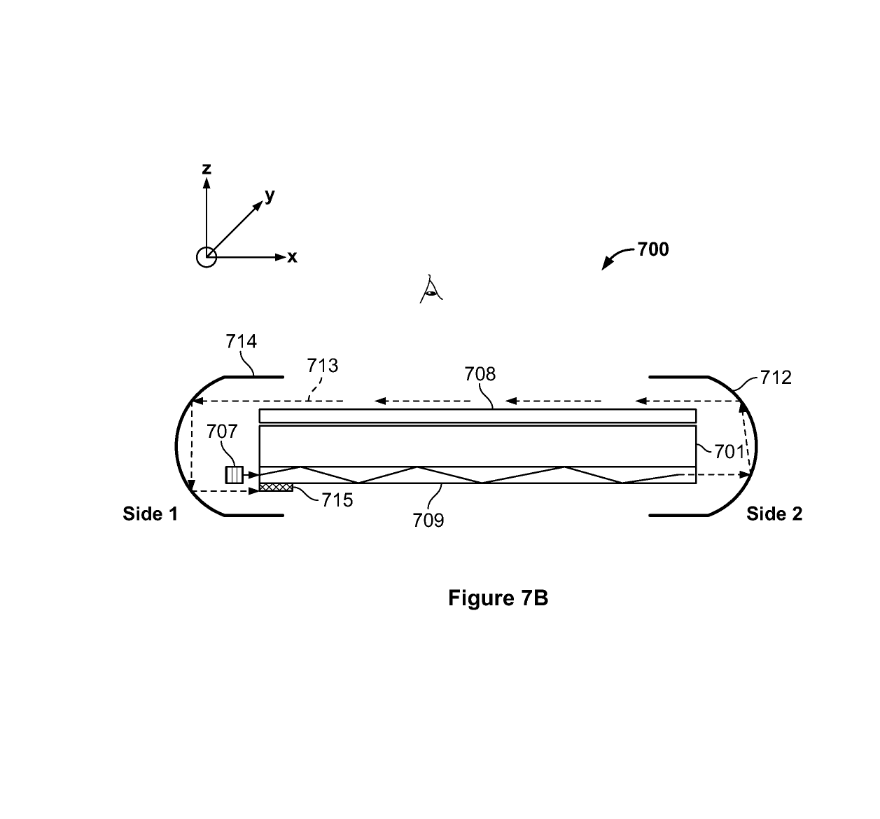

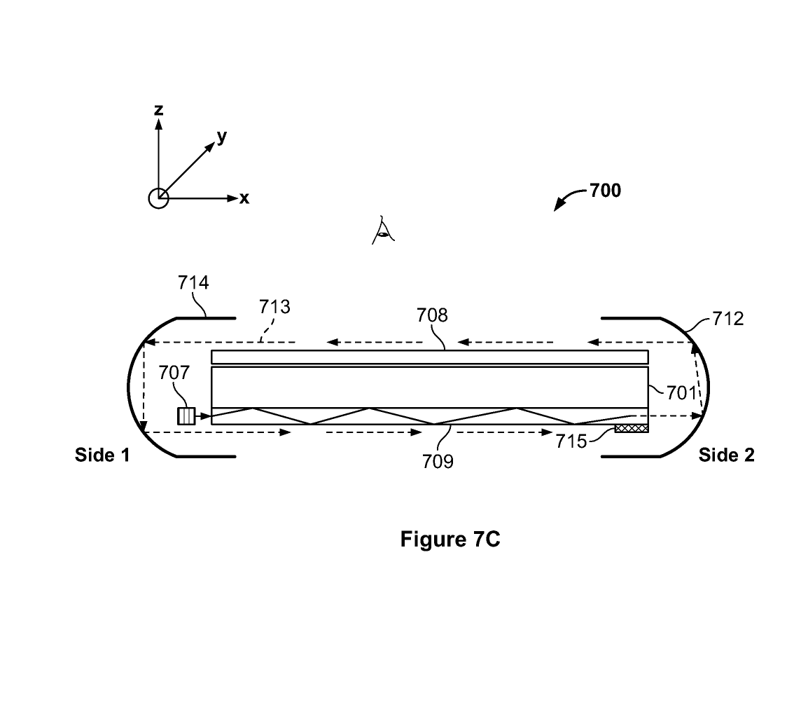

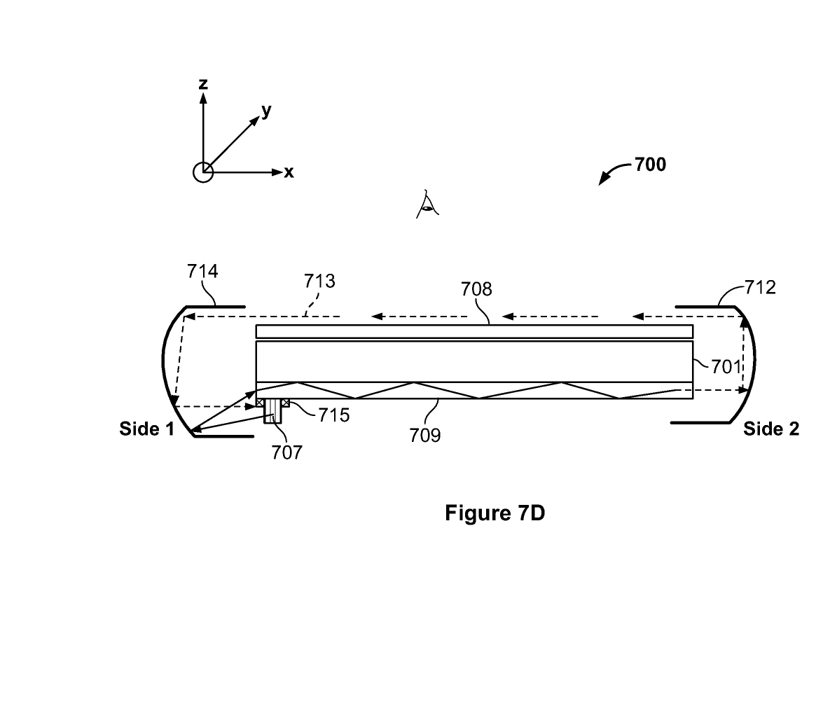

FIGS. 7A-7D illustrate cross-sectional views of various implementations of a display device including an optical touch screen and a light source configured to inject light into a backplate of the display device. The implementations of the display device 700 illustrated in FIGS. 7A-7D include a plurality of light modulating elements 701, a display touch surface 708, a display backplate 709, light redirectors 712 and 714 (FIGS. 7B-7D), a light source 707 and one or more sensors 715. In various implementations, the plurality of light modulating elements 701 can be similar to the light modulating elements 401. The plurality of light modulating elements 701 can include interferometric modulators. The plurality of light modulating elements 701 can be reflective. The display touch surface 708 can be similar to the display touch surface 608 and the touch surface 501 discussed above. Additionally, the display backplate 709 can be similar to the backplate 409 discussed above. In various implementations light redirectors 712 and 714 can be similar to the light redirector 412 and light redirector 612 discussed above. In various implementations, the light source 707 can be similar to the source of illumination 404a and 404b and the one or more sensors 715 can be similar to the waveguide receiver 504 and/or the sensor array 505 discussed above.

In the implementation of the display device 700 illustrated in FIG. 7A, the light source 707 is disposed on a first side (side 1) of the display device 700 rearward of the plurality of light modulating elements 701 and proximal to a first edge of the backplate 709 such that light emitted from the light source 707 is injected into the backplate 709 and propagates through the backplate 709 by multiple total internal reflections along the +x-direction towards a second side (side 2) of the display device 700. The light propagating through the backplate 709 exits the backplate 709 from a second edge opposite the first edge of the backplate 709. Light that exits out of the second edge of the backplate 709 is received by the light redirector 712 and raised upwards along the z-direction and forward of the plurality of light modulating elements 701 and redirected forward of the display touch surface 708, as indicated by ray 713, towards the one or more sensors 715 disposed on the first side (side 1) of the display device 700 for optical touch purpose. In various implementations, the light that propagates forward of the display touch surface 708 can be substantially collimated in a plane parallel to the X-Y plane along the display touch surface 708 and in a plane parallel to the Y-Z plane. In various implementations, the collimation of the light propagating forward of the display touch surface 708 can be achieved by using an aspheric parabolic reflector, for example, an asymmetric parabolic reflector.

The implementation of the display device 700 illustrated in FIGS. 7B and 7C include an additional light redirector 714 disposed on the first side (side 1) of the display device 700. The light redirector 714 is configured to receive light that is propagating forward of the display touch surface 708, indicated by ray 713, and redirect the received light towards the one or more sensors 715 which is disposed rearward of the plurality of light modulating elements 701. The light redirector 714 can be similar to the light redirectors 612 and 412 discussed above. For example, the light redirector 714 can be parabolic in shape (for example, an asymmetric parabolic reflector) or have some other aspheric shape. The light redirector 714 can include one or more curved surfaces, for example, the light redirector 714 can be curved in the longitudinal (x) and transverse (y) directions. In various implementations, the one or more sensors 715 can be disposed on the same side of the display device as the light source 707 as illustrated in FIG. 7B. In various implementations, the one or more sensors 715 can be disposed on the opposite side of the display device as the light source 707 as illustrated in FIG. 7C. The resolution of the detector can be selected based on the position of the one or more sensors 715. For example, if the one or more sensors 715 are disposed on the same side of the display device as the light source 707, then a long linear sensor array having low resolution can be used since the redirected light is still sufficiently collimated immediately after being redirected by the light redirector 712. However, if the one or more sensors 715 are disposed on the opposite side of the display device as the light source 707 as illustrated in FIG. 7C, then the light that is redirected by the light redirector 712 is focused down to a point source when incident on the one or more sensors 715 thus requiring a high resolution detector which can be very small in size. The light redirector 712 can be parabolic in shape (for example, an asymmetric parabola that is curved in the longitudinal (x) and transverse (y) directions) to achieve the focusing effect of the redirected light. In various implementations, the spatial resolution provided by the high resolution detector can be between 10-100 microns.

The implementation of the display device 700 illustrated in FIG. 7D also includes an additional light redirector 714 disposed on a first side (side 1) of the display device 700. The light source 707 is disposed rearward of the backplate 709 such that light from the light source 707 is directly incident on the light redirector 714. Light redirector 714 is configured to raise the light incident from the light source 707 along the z-direction and forward of the light source 707 and inject light from the light source 707 into the backplate 709. The injected light propagates through the backplate 709 from a first side (side 1) of the display device 700 to a second side (side 2) of the display device and exits the backplate 709 on the second side (side 2) of the display device 700. Light exiting the backplate 709 on the second side (side 2) of the display device is received by the light redirector 712 and raised upwards along the z-direction forward of the light modulating element 701 and is redirected forward of the display touch surface 708. The redirected light propagates forward of the display touch surface 708 from the second side (side 2) of the display device to the first side (side 1) of the display device, as indicated by ray 713, for optical touch purpose. Light redirector 714 can be further configured to receive and redirect the light propagating forward of the display touch surface 708 towards one or more sensors 715 which are disposed rearward of the backplate 709. The light redirector 712 illustrated in FIGS. 7A-7D can be a portion of a combined light redirector or a system including additional light redirectors that can direct light forward of the display touch surface 708 along a direction parallel to the x-axis and a direction parallel to the y-axis for optical touch purpose. The light redirector 714 illustrated in FIGS. 7B-7D can be a portion of a combined light redirector or a system including additional light redirectors that can receive light propagating forward of the display touch surface 708 along a direction parallel to the x-axis and a direction parallel to the y-axis and direct the received light towards one or more sensors 715.

A wide variety of other variations are also possible. For example, films, layers, components, and/or elements may be added, removed, or rearranged. The light redirectors can include planar reflectors instead of curved reflectors. Accordingly, a first portion of the light redirector can be curved (for example, parabolic) and a second portion of the light redirector can be linear (for example, cylindrical). In other embodiments, the light redirector can include Fresnel reflectors or Fresnel lenses. Furthermore, additional sources of illumination and light redirectors may be included in the various implementations described herein to provide a light grid forward of the display touch surface to determine the position of the touch input. Also, although the terms film and layer have been used herein, such terms as used herein include film stacks and multilayers. Such film stacks and multilayers may be adhered to other structures using adhesive or may be formed on other structures using deposition or in other manners.

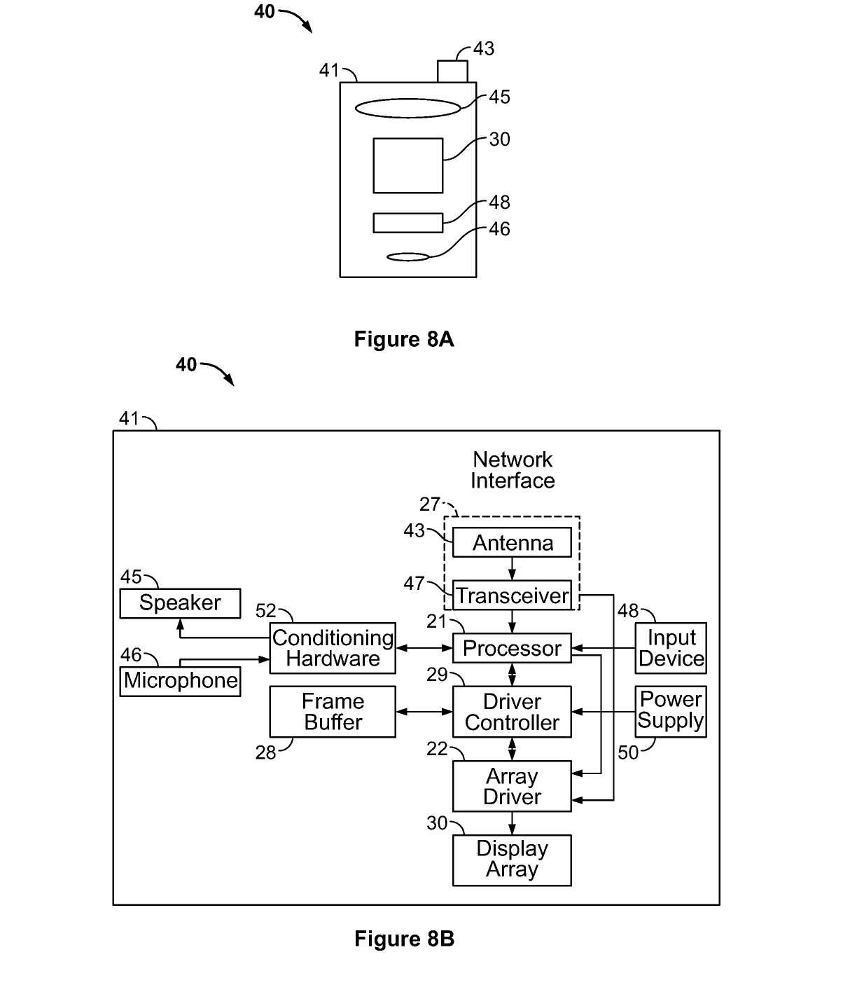

FIGS. 8A and 8B show examples of system block diagrams illustrating a display device 40 that includes a plurality of interferometric modulators. In various implementations, the display device 40 can be similar to the display devices 400, 600 and 700 discussed above. The display device 40 can be, for example, a cellular or mobile telephone. However, the same components of the display device 40 or slight variations thereof are also illustrative of various types of display devices such as televisions, e-readers and portable media players.

The display device 40 includes a housing 41, a display 30, an antenna 43, a speaker 45, an input device 48, and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber, and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein.

The components of the display device 40 are schematically illustrated in FIG. 8B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 can provide power to all components as required by the particular display device 40 design.

The network interface 27 includes the antenna 43 and the transceiver 47 so that the display device 40 can communicate with one or more devices over a network. The network interface 27 also may have some processing capabilities to relieve, e.g., data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g or n. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation, and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (e.g., an IMOD controller). Additionally, the array driver 22 can be a conventional driver or a bi-stable display driver (e.g., an IMOD display driver). Moreover, the display array 30 can be a conventional display array or a bi-stable display array (e.g., a display including an array of IMODs). In some implementations, the driver controller 29 can be integrated with the array driver 22. Such an implementation is common in highly integrated systems such as cellular phones, watches and other small-area displays.

In some implementations, the input device 48 can be configured to allow, e.g., a user to control the operation of the display device 40. The input device 48 can include a keypad, such as a QWERTY keyboard or a telephone keypad, a button, a switch, a rocker, a touch-sensitive screen, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices as are well known in the art. For example, the power supply 50 can be a rechargeable battery, such as a nickel-cadmium battery or a lithium-ion battery. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A display device comprising:
a display touch surface;
a plurality of light modulating elements configured to form a display image, the plurality of light modulating elements disposed rearward of the display touch surface;
a substrate disposed rearward of the plurality of light modulating elements, the substrate integral with the display device;
at least one light source disposed to inject light into the substrate;
one or more sensors; and
a first light redirector portion disposed laterally with respect to the plurality of light modulating elements and configured to receive light from an edge of the substrate that is proximal to the first light redirector portion, the first light redirector portion configured to direct a first portion of the received light forward of the display touch surface and the one or more sensors disposed so as to receive at least some of the first portion of the received light.

2. The device of claim 1, wherein the substrate includes a display backplate that encloses the plurality of light modulating elements to insulate the plurality of light modulating elements from the external environment.

3. The device of claim 1, wherein the plurality of light modulating elements are disposed on the substrate.

4. The device of claim 1, including a cladding layer disposed between the plurality of light modulating elements and the substrate.

5. The device of claim 1, wherein the display device includes a second light redirector portion.

6. The device of claim 5, wherein the second light redirector portion is configured to receive light propagating forward of the display touch surface and direct the light propagating forward of the touch surface towards the one or more sensors.

7. The device of claim 5, wherein the second light redirector portion is configured to receive light from the at least one light source and direct the light into an edge of the substrate that is distal to the first light redirector portion.

8. The device of claim 7, wherein the second light redirector portion is configured to receive light propagating forward of the display touch surface and direct the light propagating forward of the touch surface towards the one or more sensors.

9. The device of claim 5, wherein the first light redirector portion and the second light redirector portion include an asymmetric parabolic reflector.

10. The device of claim 1, wherein the one or more sensors are disposed rearward of the plurality of light modulating elements.

11. The device of claim 1, wherein the display touch surface has forward and rearward surfaces that extend in longitudinal (x) and transverse (y) directions and wherein the first light redirector portion includes an asymmetric parabolic reflector that is curved in the longitudinal and transverse directions, the curve having a parabolic shape so as to spread light across the forward surface of the display touch surface.

12. The device of claim 1, further including a light guide disposed forward of the plurality of light modulating elements, wherein the first light redirector portion is configured to direct a second portion of the light received from the at least one light source into an edge of the light guide to provide front illumination.

13. The device of claim 12, wherein the light guide includes a plurality of turning features configured to direct light propagating therein towards the plurality of light modulating elements to provide front illumination.

14. The device of claim 1, wherein the light source is disposed rearward of the substrate.

15. The device of claim 1, wherein the light source is disposed rearward of the plurality of light modulating elements.

16. The device of claim 1, wherein the light source is disposed rearward of the display touch surface.

17. The device of claim 1, wherein the light source is adjacent an edge of the substrate.

18. The device of claim 1, wherein the light source is disposed to illuminate a first and a second edge of the substrate, the first edge intersecting the second edge at an angle.

19. The device of claim 18, wherein the light source is disposed to inject light into a corner of the substrate.

20. The device of claim 1, wherein the one or more sensors are disposed rearward of the plurality of the light modulating elements.

21. The device of claim 1, wherein the one or more sensors are disposed rearward of the light source.

22. The device of claim 1, wherein the one or more sensors and the at least one light source are disposed on the same side of the display device.

23. The device of claim 1, wherein the one or more sensors and the at least one light source are disposed on opposite sides of the display device.

24. The device of claim 1, wherein the one or more sensors include a high resolution detector having a spatial resolution between approximately 10 microns-100 microns.

25. The display device of claim 1, wherein the plurality of light modulating elements are reflective.

26. The display device of claim 1, wherein the each of the plurality of light modulating elements include at least one interferometric modulator.

27. The device of claim 1, further comprising:
a processor that is configured to communicate with the plurality of light modulating elements, the processor being configured to process image data; and
a memory device that is configured to communicate with the processor.

28. The device of claim 27, further comprising a driver circuit configured to send at least one signal to the display device.

29. The device of claim 28, further comprising a controller configured to send at least a portion of the image data to the driver circuit.

30. The device of claim 27, further comprising an image source module configured to send the image data to the processor.

31. The device of claim 30, wherein the image source module includes at least one of a receiver, transceiver, and transmitter.

32. The device of claim 27, further comprising an input device configured to receive input data and to communicate the input data to the processor.

33. A display device comprising:
a display touch surface;
a plurality of means for modulating light, the light modulating means configured to form a display image, the plurality of light modulating means disposed rearward of the display touch surface;
a substrate disposed rearward of the plurality of light modulating means, the substrate integral with the display device;
at least one means for illumination, the at least one illumination means disposed to inject light into the substrate;
one or more means for sensing light; and
a first means for redirecting light, the first light redirecting means disposed laterally with respect to the plurality of light modulating means and configured to receive light from an edge of the substrate that is proximal to the first light redirecting means, the first light redirecting means configured to direct a first portion of the received light forward of the display touch surface towards the one or more sensing means, wherein the directed first portion of light propagates forward of the touch surface.

34. The device of claim 33, wherein the plurality of light modulating means includes a plurality of light modulating elements, or the at least one illumination means includes at least one light source, or the first light redirecting means includes a first light redirector; or the one or more sensing means includes one or more sensors.

35. The device of claim 33, wherein the plurality of light modulating elements includes at least one interferometric modulator.

36. The device of claim 33, wherein the first light redirector includes an asymmetric parabolic reflector.

37. The device of claim 33, wherein the substrate includes a backplate of the display device that encloses the plurality of light modulating means to insulate the plurality of light modulating means from the external environment.

38. A method of manufacturing a display device, the method comprising:
providing a display touch surface;
providing a plurality of light modulating elements configured to form a display image, the plurality of light modulating elements disposed rearward of the display touch surface;
disposing a substrate rearward of the plurality of light modulating elements, the substrate integral with the display device;
providing at least one light source to inject light into the substrate;
providing one or more sensors; and
disposing a first light redirector laterally with respect to the plurality of light modulating elements, the first light redirector configured to receive light from an edge of the substrate that is proximal to the first light redirector, the first light redirector configured to direct a first portion of the received light forward of the display touch surface towards the one or more sensors, wherein the directed first portion of light propagates forward of the touch surface.

39. The method of claim 38, wherein the plurality of light modulating elements includes at least one interferometric modulator.
